(19) United States
(12) Patent Application Publication
(10) Pub. No.: US 2026/0288805 A1
(43) Pub. Date: Sep. 24, 2026

(54) SYSTEM

(71) Applicant: SoftBank Group Corp., Tokyo (JP)

(72) Inventor: Soshi KOYAMA, Tokyo (JP)

(73) Assignee: SoftBank Group Corp., Tokyo (JP)

(21) Appl. No.: 19/565,539

(22) Filed: Mar. 13, 2026

(30) Foreign Application Priority Data
Mar. 19, 2025 (JP) 2025-045143

(51) Int. Cl. G06F 16/3329; G06F 16/335

(52) U.S. Cl. CPC G06F 16/33295; G06F 16/335

(57) ABSTRACT

A system includes a processor that is configured to analyze, by using a generative AI model, a profile, an interest, and a past behavior pattern of a user, and generate a prompt for instructing provision of higher-accuracy matching based on a result of the analysis, analyze, by using the generative AI model, a conversation or a message, and generate a prompt for instructing provision of support for more effective communication based on a result of the analysis, and recognize an emotion of the user and generate a prompt for instructing adjustment of a matching candidate based on the emotion, wherein the prompts are configured to be input to the generative AI model to cause the generative AI model to perform processing corresponding to the instructions.

### CROSS-REFERENCE TO RELATED APPLICATION

This application is based on and claims priority under 35 USC 119 from Japanese Patent Application No. 2025-045143 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional matching applications and communication support systems, analysis of user profiles, interests, and past behavior patterns is often based on fixed rules or simple statistical models. As a result, the accuracy of user matching is limited, and the system is not capable of flexibly adapting to complex and changing user preferences. Furthermore, conventional systems provide only basic communication assistance, such as template messages, and do not sufficiently support effective, context-aware communication in conversations or messages between users.

In addition, known systems generally do not recognize user emotions in a detailed manner, nor do they dynamically adjust matching candidates or communication support based on such emotional states. As a result, user satisfaction and engagement with the service are reduced. Moreover, although generative AI models have become capable of producing highly flexible responses and content, there is no adequate mechanism for generating appropriate prompts that can effectively instruct such generative AI models to perform specific processing for matching, communication support, and automatic answering to user questions.

Accordingly, there is a need for a system that can: (i) analyze a user's profile, interests, and past behavior patterns by using a generative AI model; (ii) generate prompts that instruct the generative AI model to provide higher-accuracy matching; (iii) analyze conversations or messages and generate prompts that instruct the generative AI model to provide more effective communication support; (iv) recognize user emotions and generate prompts that instruct the generative AI model to adjust matching candidates based on the recognized emotions; and (v) generate prompts that instruct the generative AI model to automatically generate matching candidates and answers to user questions.

### SUMMARY

In order to solve the above-described problems, a system according to one aspect of the present invention comprises a processor, wherein the processor is configured to analyze, by using a generative AI model, a profile, an interest, and a past behavior pattern of a user, and generate a prompt for instructing provision of higher-accuracy matching based on a result of the analysis. By generating such prompts, the processor causes the generative AI model to perform matching processing that reflects detailed and complex user preferences, thereby improving the accuracy and personalization of matching candidates.

The processor is further configured to analyze, by using the generative AI model, a conversation or a message, and generate a prompt for instructing provision of support for more effective communication based on a result of the analysis. In this manner, the system enables the generative AI model to generate context-aware reply suggestions, communication strategies, or other supportive content that improves the quality of interactions between users.

Moreover, the processor is configured to recognize an emotion of the user and generate a prompt for instructing adjustment of a matching candidate based on the emotion. By recognizing emotional states, such as anxiety, excitement, or dissatisfaction, and by reflecting such states in the prompts, the system allows the generative AI model to adapt the matching strategy, including the selection and presentation of candidates, to the current emotional condition of the user.

According to another aspect, the processor is configured to generate a prompt for instructing automatic generation, by the generative AI model, of the matching candidate based on a behavior pattern of the user. This enables autonomous operation of the matching function in response to behavioral trends, without requiring manual rule tuning.

According to still another aspect, the processor is configured to generate a prompt for instructing automatic generation, by the generative AI model, of an answer to a question received from the user. Thus, the system can provide detailed, context-sensitive answers and advice related to matching, communication, and other concerns, by effectively utilizing the capabilities of the generative AI model through appropriately structured prompts.

The term “processor” refers to any hardware or combination of hardware and software components configured to execute instructions, including but not limited to a central processing unit (CPU), a microprocessor, a digital signal processor, a graphics processing unit (GPU), an application-specific integrated circuit (ASIC), a field-programmable gate array (FPGA), or a distributed computing system.

The term “generative AI model” refers to a machine learning model configured to generate outputs such as text, images, audio, or other data in response to input data or prompts, including but not limited to large language models, transformer-based models, generative adversarial networks (GANs), variational autoencoders (VAEs), and other neural network-based generative architectures.

The term “prompt” refers to data representing an instruction, query, context, or other information that is provided as input to the generative AI model to cause the generative AI model to perform specified processing and to generate corresponding output.

The term “profile” refers to information associated with a user that describes attributes of the user, including but not limited to age, gender, occupation, hobbies, preferences, location, and self-introduction information.

The term “interest” refers to a preference, liking, or tendency of a user toward particular topics, activities, categories of persons, or content, which may be explicitly provided by the user or implicitly inferred from user behavior.

The term “past behavior pattern” refers to historical behavioral data of a user, including but not limited to records of likes, skips, matches, messages, responses, viewing history, and interaction frequencies, from which tendencies and patterns of the user's actions can be derived.

The term “matching” refers to a process of selecting, ranking, or presenting one or more candidate users or entities that are estimated to be suitable partners or counterparts for a given user based on profile information, interests, behavior patterns, emotions, or other data.

The term “matching candidate” refers to a user or entity proposed as a potential partner or counterpart for a given user in a matching process, as well as information representing such user or entity.

The term “conversation” refers to an exchange of messages, text, audio, or other communicative content between a user and another user or system, including both synchronous and asynchronous communications.

The term “message” refers to a discrete unit of communication transmitted between users or between a user and a system, such as a text message, chat message, email, or similar communication content.

The term “communication support” refers to assistance provided to a user to facilitate or improve communication, including but not limited to generating or suggesting reply messages, proposing topics, adjusting tone or style, and providing guidance on conversational strategies.

The term “emotion” refers to an affective state of a user, including but not limited to happiness, sadness, anxiety, excitement, anger, interest, or boredom, which may be detected or inferred from user input, behavior, physiological signals, or contextual information.

The term “question received from the user” refers to an inquiry, request for information, or consultation content submitted by the user to the system in natural language or another form, which is intended to obtain an answer, explanation, or advice from the system.

The term “automatic generation” refers to generation of content, such as matching candidates or answers, by the generative AI model without requiring manual specification of the detailed content by a human operator for each output instance, based on the prompts and input data provided.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

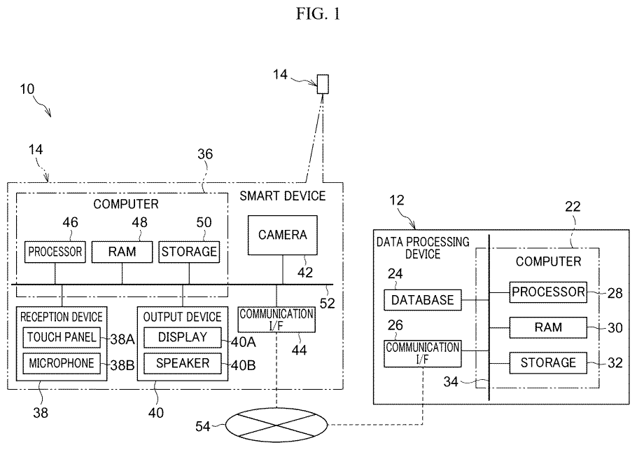

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

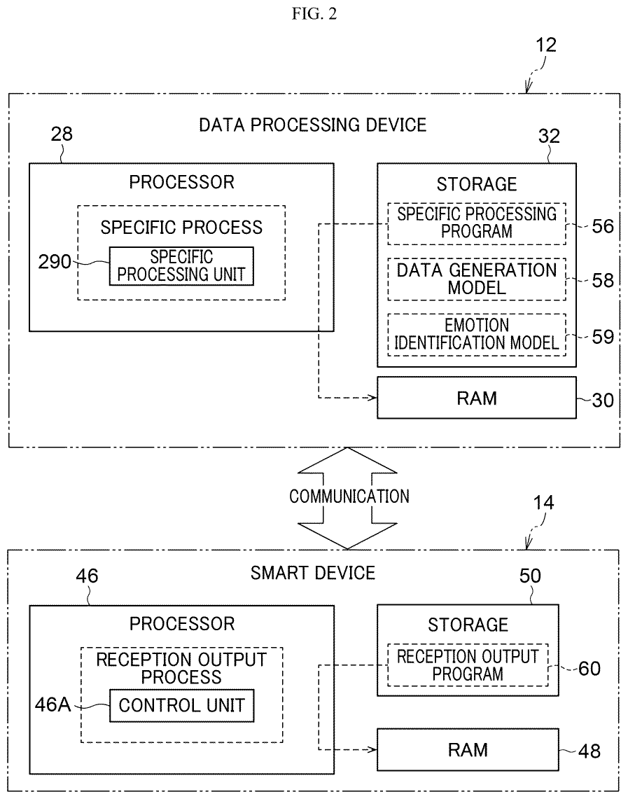

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional information processing systems that provide matching and communication support typically rely on static rule sets or simple statistical models running on general-purpose computer hardware. Such systems suffer from several technical limitations in terms of how data is represented, how heterogeneous data streams are integrated, and how model computation is orchestrated on a processor.

First, conventional systems often handle user attribute information, preference information, behavior history information, and communication history information as separate data silos. The processor frequently accesses these heterogeneous data items via multiple independent procedures without a unified representation. This leads to inefficient memory access patterns, redundant data retrieval, and increased processing latency, particularly when generating recommendations or support information in real time.

Second, many existing systems invoke machine learning or recommendation engines as opaque components without explicit control over how input data is structured or how instructions to the model are expressed. In particular, conventional architectures do not define a systematic mechanism by which a processor converts multi-modal user data into structured prompt sentences and associated feature data tailored to a generative artificial intelligence model. As a result, the generative artificial intelligence model cannot be efficiently guided to perform compound tasks such as user preference estimation, candidate selection, and interpersonal advice generation in a single coordinated inference process. This causes suboptimal utilization of computational resources and degrades throughput and responsiveness.

Third, traditional matching engines frequently compute recommendation candidates from historical data in batch mode and do not continuously adapt to new behavior history information and communication history information. From a computer-technical perspective, this results in stale data structures, outdated feature vectors, and repeated full recomputation. The lack of an incremental update pipeline on the processor side leads to unnecessary processor cycles, increased input/output operations to storage, and a poor tradeoff between accuracy and computational cost.

Fourth, communication-analysis components in conventional systems often operate independently from matching components, using separate models or heuristic rules. The processor thus has to manage multiple disjoint processing paths, which complicates control flow and increases the overhead of synchronizing intermediate results. In particular, advice related to interpersonal issues is typically generated without tight coupling to the same user representations that drive matching. This disconnect leads to duplicated feature extraction, inconsistent intermediate data formats, and inefficient utilization of memory and execution units.

There is therefore a need for an improved computer-implemented system and processing method in which a processor unifies the acquisition, storage, preprocessing, and representation of user-related data, and in which the processor constructs and supplies structured prompt sentences and corresponding input data to a generative artificial intelligence model in a coordinated manner. Such a system should enable the processor to derive, in a single integrated framework, both matching candidates and interpersonal advice, while continuously updating stored information and model input data in response to new behavior and communication history. By doing so, the system can improve the efficiency of data processing, reduce redundant computations, optimize the utilization of generative artificial intelligence models, and enhance the overall technical performance of the computer system with respect to latency, scalability, and adaptability of its recommendation and support functions.

The specific processing by the specific processing unit 290 of the data processing device 12 in Example 1 is realized by the following means.

The present invention provides a server comprising a processor and a storage, the processor being configured to acquire attribute information, preference information, behavior history information, and communication history information of a user from a terminal; store the acquired information in the storage in association with the user; preprocess the stored information to generate numerical feature data and text feature data as unified input data for a generative artificial intelligence model; generate prompt sentences that include summaries of the stored information and that instruct the generative artificial intelligence model to estimate user interests and preferences, to select candidate targets, to extract issues in interpersonal relationships, and to generate advice information; input the prompt sentences and the unified input data to the generative artificial intelligence model and obtain response data including relevance information, explanation information, and advice information; determine matching candidates or service candidates by extracting, scoring, and ranking candidates based on the response data and the stored information; present the determined candidates and the advice information to the user; and continuously update the stored information and the unified input data based on newly acquired behavior history information and communication history information so as to iteratively refine subsequent determinations of candidates and advice information. This enables an integrated computer-implemented processing pipeline in which heterogeneous user-related data are represented and controlled in a coordinated manner for interaction with a generative artificial intelligence model, thereby improving the efficiency and responsiveness of matching and communication-support computations, reducing redundant data processing, and enhancing the overall technical performance of the server in executing recommendation and advice-generation tasks.

The term “system” refers to a combination of one or more computing devices including at least a processor and a storage, configured to execute the functions described in the claims.

The term “processor” refers to one or more hardware processing units, such as a central processing unit or a processing core, capable of executing machine-readable instructions to perform logical operations, arithmetic operations, data movement, and control flow in accordance with a program.

The term “storage” refers to one or more hardware storage components, such as a memory device or a non-volatile storage device, configured to store data, parameters, and program instructions accessible by the processor.

The term “terminal” refers to an electronic device operated by a user, such as a portable communication device, a personal computing device, or a display-equipped input device, that is configured to transmit data to and receive data from the server.

The term “user” refers to an individual or an entity that interacts with the system through the terminal and whose data are processed by the processor.

The term “attribute information” refers to profile-related data associated with a user, including but not limited to demographic information, characteristic information, and registration information, which are used to describe static or relatively slowly changing aspects of the user.

The term “preference information” refers to data indicating interests, likes, dislikes, or inclinations of a user, which may be explicitly provided by the user or inferred from other types of data.

The term “behavior history information” refers to data indicating past operations, actions, or selections performed by a user through the terminal, including but not limited to viewing actions, selection actions, reaction actions, and communication actions, together with associated timestamps or contextual information.

The term “communication history information” refers to data representing messages, conversational exchanges, or other communication content transmitted or received by a user through the system, including associated metadata such as sender, recipient, and time of transmission.

The term “generative artificial intelligence model” refers to a machine-learned model, implemented in software and executed by hardware, that is configured to generate output data such as text, scores, or other structured information in response to input data, according to parameters obtained through a training process.

The term “prompt sentence” refers to text data or a structured textual instruction generated by the processor and supplied as input to the generative artificial intelligence model, the text data specifying a task or behavior to be performed by the model and providing context or constraints for generation.

The term “input data” refers to data supplied to the generative artificial intelligence model, including numerical feature data, text feature data, prompt sentences, or any combination thereof, which are used by the model to produce response data.

The term “numerical feature data” refers to data in a numeric representation derived from user-related information, such as vectors, matrices, or scalars, suitable for processing by machine-learning algorithms or numerical computation routines.

The term “text feature data” refers to data representing textual information in a structured form, including token sequences, token identifiers, embeddings, or other representations derived from natural-language text.

The term “summary content” refers to data that condense or abstract a larger set of user-related information, such as attribute information, preference information, behavior history information, or communication history information, into a shorter representation used to guide processing by the generative artificial intelligence model.

The term “response data” refers to data generated by the generative artificial intelligence model in response to input data and a prompt sentence, including scores, labels, explanation text, advice text, or other structured outputs.

The term “relevance information” refers to data indicating a degree of suitability, similarity, or association between a user and a candidate target, represented for example as scores, rankings, or probability values.

The term “explanation information” refers to data that describe reasons, factors, or grounds for selecting or evaluating a candidate target, typically provided in natural-language text or structured descriptors.

The term “advice information” refers to data generated by the generative artificial intelligence model that provide suggestions, guidance, or recommended actions to a user, particularly in relation to interpersonal interactions or communication.

The term “candidate target” refers to an entity such as another user, a content item, or a service item, that is considered as a possible match or recommendation for a given user.

The term “matching candidate” refers to a candidate target that is selected or evaluated as a potential match for a user based on the processed information and model outputs.

The term “service candidate” refers to a candidate target that corresponds to a service, content, or offering to be recommended to a user.

The term “scoring” refers to a process in which the processor assigns numeric values or comparable metrics to candidate targets based on relevance information, model outputs, or rule-based criteria.

The term “ranking” refers to a process in which the processor orders candidate targets according to scores, metrics, or other evaluation criteria so as to determine a preference order.

The term “behavior tendency” refers to a pattern or classification of user behavior derived from analysis of behavior history information, indicating typical action styles or recurring operation patterns of the user.

The term “profile information” refers to a set of data describing characteristics of a user or a candidate target, including attribute information, preference information, or other associated descriptors.

The term “interpersonal relationships” refers to relational states, interactions, or connections between a user and another user or entity, as inferred from communication history information or behavior history information.

The term “communication support information” refers to information presented to a user to assist in conducting or improving communication, including advice information, suggested messages, or recommended communication strategies.

In one embodiment, a server includes a processor, a memory, a non-volatile storage device, and a network interface. The server executes an operating system such as a general-purpose server operating system and executes application software implemented, for example, using a server-side framework and a numerical computation library. The server communicates with one or more terminals over a packet-based network using a secure communication protocol such as HTTPS. The terminals are implemented as portable communication devices or personal computing devices and execute a client application that includes a user interface and network communication functions. A user operates the terminal to input data and to receive matching candidates and communication support information.

The server stores program instructions in the non-volatile storage device. When the server starts, the processor loads the program instructions into the memory and executes the program to implement the functions of acquiring user-related data, preprocessing such data, generating prompt sentences, controlling a generative AI model, post-processing model outputs, and managing continuous updates.

The terminal presents graphical user interface elements that allow the user to input attribute information such as age, region, and broad categories of interests; to specify preference information such as favored activity types or content genres; and to perform actions such as viewing candidate profiles, sending reactions, and exchanging messages. The terminal converts the input of the user into structured data objects and transmits these data objects to the server. The terminal also receives response data from the server and renders candidate targets and advice information on a display.

The server organizes user-related data in structured data stores. The server stores attribute information, preference information, behavior history information, and communication history information in separate data structures such as relational tables or key-value records. For example, the server stores, for each user, attribute fields (age, region category, occupation category), preference fields (interest categories, preferred activity tags), and behavior logs (event type, target identifier, timestamp). The server also stores communication history as message records including sender identifier, recipient identifier, timestamp, and textual content.

The server prepares data for processing by a generative AI model by converting heterogeneous user-related data into unified feature representations. The server uses a numerical computation library to convert categorical fields into vector indices, and to perform one-hot encoding or embedding lookups. The server assigns an index to each category such as a hobby category, an occupation category, or a region cluster. The server then generates a sparse vector for each category field and, in some embodiments, multiplies such vectors by embedding matrices to obtain low-dimensional dense feature vectors. The server normalizes numerical quantities such as age, counts of actions, or time-of-day usage histograms by applying scaling functions so that numerical feature values fall within predefined ranges. This results in numerical feature data that are stored in memory as floating-point arrays.

The server also processes communication history information as text. The server applies a tokenizer to each message text and converts the text to token identifiers based on a predefined vocabulary. The server then generates token sequences and, when necessary, truncates or pads the sequences to a fixed length. The server stores token sequences as arrays of integer values. In some embodiments, the server uses a separate text encoder to convert token sequences into text feature data in the form of embedding vectors. The server may cache these feature data for reuse in subsequent inferences to reduce repeated computation and memory access.

The server generates prompt sentences to instruct the generative AI model to perform specific tasks. The server constructs prompt sentences as natural-language strings that embed summary content of the user-related data and specify human-readable tasks. For example, when the server controls the generative AI model to estimate user interests and generate matching candidates, the server forms a prompt sentence such as:
“The system receives the following user profile and behavioral history. Analyze the user's interests and preferences and generate a list of optimal combination candidates (other users or services) with brief reasons. Data: age group, region category, interest categories, and recent actions toward profiles tagged with outdoor activities.”

When the server controls the generative AI model to generate interpersonal advice, the server forms a prompt sentence such as:
“Analyze the following communication history between two users. Identify possible interpersonal problems, misunderstandings, or tensions, and generate concrete, polite advice that one user can follow to improve the relationship. Conversation summary: repeated schedule changes and short replies from the counterpart.”

These prompt sentences provide explicit instructions and context to the generative AI model so that the model focuses its computation on specific, well-defined tasks.

The server implements the generative AI model as a neural network having a sequence-processing architecture. In one embodiment, the server uses a transformer-based architecture that includes an embedding layer, a plurality of self-attention layers, and feed-forward layers.

The server stores model parameters such as weight matrices for attention, projection, and feed-forward layers in the non-volatile storage device and loads these parameters into memory at initialization time. The server further configures the processor and, where available, a graphics processing unit to perform matrix multiplication, vector addition, and non-linear activation functions required by the neural network computations.

The server trains the generative AI model in an offline environment using historical user-related data. The server constructs training examples that include input sequences (prompt sentences and feature annotations) and target sequences or labels (candidate-target descriptions, advice sentences, or relevance labels). The server computes a loss function such as cross-entropy between model-generated tokens and target tokens, or between predicted relevance scores and ground-truth labels. The server uses an optimization algorithm, such as a gradient-based optimizer, to update model parameters by computing gradients through backpropagation and applying parameter updates. During training, the server may perform data augmentation, such as shuffling, subsampling, or paraphrasing prompts, so that the model generalizes to various phrasings and data distributions.

The server executes the generative AI model in inference mode when serving users. The server assembles a batch of prompt sentences and associated feature vectors, converts them into input tensors, and forwards them through the embedding, attention, and feed-forward layers. The server obtains either token probabilities or vector outputs at the final layer. For prediction of matching candidates, the server may use the final hidden representation of a special position in the sequence as a summary vector and feed this summary vector into a classification head that outputs scores for multiple preference categories or candidate clusters. For advice generation, the server performs autoregressive decoding, sequentially selecting tokens based on probability distributions and previously generated tokens, optionally employing beam search or top-k sampling to balance diversity and coherence.

The server performs additional computations to map model outputs to concrete candidate targets. The server maintains separate vectors representing candidate targets, which may be other users or services. The server may compute these candidate vectors by averaging or otherwise combining attribute features and behavior features of each candidate. The server then computes similarity measures between the user's summary vector and each candidate vector. The server uses vector operations such as dot products and normalization to obtain similarity scores such as cosine similarity. The server ranks candidate targets by these similarity scores and may include relevance information produced by the classification head of the generative AI model. The server then applies rule-based filters such as removing blocked users, enforcing age-range constraints, or excluding inactive services.

The server generates explanation information for the user by combining the model's token outputs and intermediate signals. For example, if the model indicates high attention weights on certain hobby categories or recently liked tags, the server may select those items as explanation factors. The server then constructs a brief explanation sentence such as “This candidate is recommended because both profiles show strong interest in outdoor activities and weekend travel.” This explanation information is included in the response data sent to the terminal.

The terminal receives the response data from the server and displays matching candidates and advice information. The terminal presents the candidates as a ranked list or grid, accompanied by explanation text. The terminal also shows the advice information in a dedicated section. The user reads the information and may change actions accordingly, for example, by initiating communication with a candidate or by adjusting message content.

The server continuously updates stored information and model input data. The server records new behavior history information as the user interacts with candidates and sends messages. The server aggregates event counts, updates statistical summaries, and recalculates derived features such as frequency of specific tag interactions or time-of-day behavior distributions. These updates alter the numerical feature data and text feature data. The server then uses the updated features as inputs to the generative AI model in subsequent inferences, which improves the relevance and timeliness of matching candidates and advice.

The server thus improves computer technology in several respects. By unifying heterogeneous user-related data into structured numerical feature data and text feature data, the server reduces redundant data retrieval and conversion. The server maintains cached feature vectors and precomputed text encodings, which reduces repeated computation and memory access, thereby lowering processing latency. By centrally generating prompt sentences that explicitly describe tasks and context, the server coordinates multiple subtasks—preference estimation, candidate selection, and interpersonal advice generation—within a single generative AI model invocation, which reduces the number of model calls, network transfers, and separate inference passes. This coordination leads to improved throughput and reduced resource utilization on the server hardware.

The server uses non-conventional, model-guided processing rules that differ from manually encoded rule sets. For example, the server clusters behavior tendencies using learned embeddings and similarity metrics rather than human-defined categories alone. The server also employs attention-based weighting within the generative AI model to emphasize specific segments of communication history that have high predictive value for interpersonal issues, such as sequences of negative responses or schedule conflicts. These learned internal processing rules allow the server to exploit high-dimensional patterns that are not practically accessible by manual human analysis, improving prediction accuracy and advice quality beyond simple automation of human judgment.

The server implements specific data structures and control flows that reduce communication load and improve scalability. For instance, the server transmits only summarized feature data and prompt content to the generative AI model process, which may run on a dedicated inference node, rather than transmitting full raw histories. This reduces network bandwidth and internal memory traffic. The server also batches multiple inference requests and processes them in parallel on vectorized hardware units, which reduces per-request overhead and improves processing speed. The combination of hierarchical data representation, prompt-based orchestration, and parallel inference yields measurable improvements in latency and throughput compared to conventional architectures.

The server may employ variations of the generative AI model and data-processing pipeline in alternative embodiments. In one variation, the server uses a hybrid architecture in which a recommendation sub-model computes candidate scores from numerical feature data, and a text-generation sub-model produces explanation and advice text from prompt sentences. The server coordinates the two sub-models through a shared embedding space. In another variation, the server updates a subset of model parameters online using recent interaction data to adapt to changing user behavior patterns, while keeping the majority of parameters fixed for stability. The server may also change the structure of prompt sentences depending on device constraints of the terminal, such as shorter prompts for low-bandwidth connections and longer prompts with richer context when sufficient resources are available.

By designing the system so that the server manages data structures, feature transformations, prompt generation, model execution, candidate mapping, and continuous updating in an integrated manner, the invention provides a concrete improvement to the functioning of the computer system itself. The server achieves higher accuracy of matching and interpersonal advice with fewer inference calls, lower latency, and reduced communication and computation overheads, thereby demonstrating a technical effect that goes beyond merely automating human decision making.

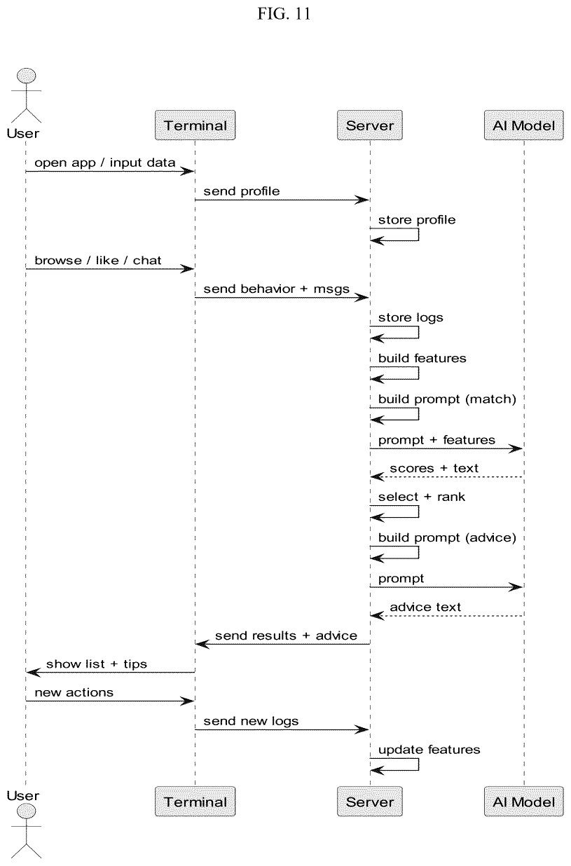

The following describes the processing flow using FIG. 11.

### Step 1

The user operates the terminal to start an application and access the server. The terminal displays input screens for attribute information and preference information. The input of this step is user interactions such as taps and text entries on the terminal. The terminal converts these interactions into structured data, including fields for age, region category, interest categories, and initial preferences, and the output is a structured profile data object in memory on the terminal.

### Step 2

The terminal validates the structured profile data and transmits it to the server. The input of this step is the profile data object created in Step 1. The terminal checks required fields, formats, and value ranges, then serializes the data into a message format and sends it via a network protocol to a server endpoint. The output is a network message containing the user's attribute information and preference information delivered to the server.

### Step 3

The server receives the network message and stores the profile data in a storage device. The input of this step is the transmitted profile data received through the network interface. The server parses the message, extracts individual fields, and writes them into structured records in a data store, associating them with a user identifier. The output is a set of stored database records that represent the user's attribute information and preference information.

### Step 4

The user operates the terminal to browse candidate profiles and send reactions or messages. The input of this step is the set of candidate items already displayed on the terminal and the user's actions, such as scrolling, tapping a “like” control, or typing a message. The terminal captures these actions as behavior events with event type, target identifier, and timestamp, and the output is a sequence of behavior history entries and optional message texts held in a buffer on the terminal.

### Step 5

The terminal transmits the buffered behavior history entries and message texts to the server. The input of this step is the buffered event data generated in Step 4. The terminal groups events into a batch, encodes them as structured messages, and sends them to behavior logging and messaging endpoints on the server. The output is a set of network messages containing behavior history information and communication history information received by the server.

### Step 6

The server receives the behavior history information and communication history information, and updates persistent storage. The input of this step is the set of network messages received in Step 5. The server parses each message, extracts event types, target identifiers, timestamps, and message texts, and inserts them into behavior log records and message records in the data store. The server may also update aggregated counters and statistics per user. The output is updated behavior logs, communication logs, and aggregate statistics stored in the database.

### Step 7

The server generates numerical feature data from the stored attribute information, preference information, and behavior history information. The input of this step is the set of stored records for a particular user, including attributes, preferences, and behavior logs. The server performs data processing operations including category indexing, one-hot encoding, embedding lookup, counting of specific actions, and normalization of numerical values. The output is numerical feature vectors representing the user's profile, preferences, and behavior tendencies.

### Step 8

The server generates text feature data from the stored communication history information. The input of this step is a selected subset of message texts between the user and other users. The server tokenizes each message using a tokenizer, maps characters or words to token identifiers, and optionally passes the token sequences through a text encoder to produce text embeddings. The server may also combine multiple messages into a summarized representation using averaging or a separate summarization model. The output is token sequences and text feature vectors that represent the communication history.

### Step 9

The server constructs summary content and a prompt sentence for preference analysis and matching. The input of this step is the numerical feature vectors from Step 7 and the corresponding raw or summarized profile data. The server generates a textual description of the user, concatenating age group, region category, main interest categories, and frequent behavior patterns. The server then embeds this description in a natural-language instruction such as: “The system receives the following user profile and behavioral history. Analyze the user's interests and preferences and generate a list of optimal combination candidates (other users or services) with brief reasons.” The output is a prompt sentence string that explicitly instructs the generative AI model how to process the user's data.

### Step 10

The server creates input tensors for the generative AI model and feeds the prompt sentence and feature vectors to the model. The input of this step is the prompt sentence from Step 9 and the numerical feature vectors from Step 7. The server encodes the prompt sentence into token identifiers, combines them with positional encodings, and aligns the numerical feature vectors with corresponding positions or side-channel inputs. The server then forms tensors with specific shapes and passes these tensors to the generative AI model. The output is internal activations of the model and, finally, model output tokens or vectors that represent relevance information, explanation information, or text describing suitable candidate types.

### Step 11

The server post-processes the output of the generative AI model to obtain relevance information and explanation information. The input of this step is the model outputs from Step 10, such as probability distributions over categories, cluster identifiers, and generated text. The server interprets scores as relevance measures, extracts key tokens or phrases that describe reasons, and maps any predicted category identifiers back to semantic labels. The output is a structured set of relevance scores for preference categories and short textual explanations usable for candidate selection and user-facing messages.

### Step 12

The server selects candidate targets based on the relevance information and stored candidate representations. The input of this step is the relevance scores and explanation fragments from Step 11, together with stored feature vectors for potential candidate targets (other users or services). The server computes similarity metrics, such as cosine similarity, by performing vector dot products and normalization between the user's feature vector and each candidate's feature vector. The server then applies rule-based filters and sorts the candidates by a composite score derived from similarity and model relevance scores. The output is a ranked list of candidate targets, each associated with an explanation.

### Step 13

The server constructs a summary of communication history and a prompt sentence for interpersonal advice generation. The input of this step is the text feature data and message logs from Step 8. The server selects representative messages, compresses them into a shorter narrative or key points, and generates a textual summary of the relationship context. The server then constructs a prompt sentence such as: “Analyze the following communication history between two users. Identify possible interpersonal problems, misunderstandings, or tensions, and generate concrete, polite advice that one user can follow to improve the relationship. Conversation summary: [summary text].” The output is a prompt sentence specifically tailored for advice generation.

### Step 14

The server feeds the advice-generation prompt sentence to the generative AI model and generates advice information. The input of this step is the prompt sentence created in Step 13. The server tokenizes the prompt sentence, forms input tensors, and executes the generative AI model in autoregressive decoding mode. The model outputs tokens one by one, and the server collects these tokens into a complete advice text that may include multiple sentences. The output is a natural-language advice string that provides concrete guidance for the user's interpersonal communication.

### Step 15

The server packages the ranked candidate targets and advice information into a response message and sends it to the terminal. The input of this step is the ranked list of candidates from Step 12 and the advice text from Step 14. The server formats the data into a structured response message, including identifiers, summary fields, and explanation text for each candidate, plus a field containing the advice text. The server then transmits this response message through the network interface to the terminal. The output is a network response received at the terminal.

### Step 16

The terminal receives the response message and displays the matching candidates and advice information to the user. The input of this step is the response message from Step 15. The terminal parses the message, constructs data structures for candidate items and advice text, and updates the user interface. The terminal renders candidate cards or list entries with names, key attributes, and explanation text, and shows the advice information in a dedicated area. The output is a graphical display on the terminal that the user can view and interact with.

### Step 17

The user observes the displayed candidates and advice, and initiates further actions. The input of this step is the presented information on the terminal display. The user may tap on particular candidate items, send new messages influenced by the advice, or change preferences. These operations generate new interaction events on the terminal. The output is a new set of behavior events and communication texts that will be captured and processed again by the terminal and server in subsequent iterations.

### Step 18

The server updates feature data and model inputs based on new behavior and communication history. The input of this step is the newly stored behavior logs and communication logs resulting from the user's subsequent actions. The server recomputes or incrementally updates counts, frequencies, and embeddings, and may adjust summary content used in prompt sentences. The server thus modifies numerical feature vectors and text feature vectors so that they reflect the most recent state of user behavior and communication. The output is an updated feature representation and revised summary content, which are used as inputs in future executions of Steps 9 through 14 to refine matching candidates and advice.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation systems typically rely on static rule-based logic or precomputed ranking models that use only coarse user profile data or historical purchase logs. Such systems often fail to adapt in real time to a user's in-store context, such as the user's current location within a physical facility, a current budget constraint, or rapidly changing interests. As a result, the generated recommendations are frequently generic, poorly timed, and insufficiently relevant, which leads to low user engagement and low conversion rates.

Further, although generative AI models have recently become capable of producing natural language explanations and proposals, conventional systems generally apply such models in a naive manner. For example, they issue simple, fixed prompt sentences that do not incorporate detailed, machine-learned feature representations of the user, do not reflect the user's real-time physical context, and do not adapt over time based on explicit or implicit user feedback. This leads to inefficient use of computational resources and yields verbose or unfocused messages that do not improve the underlying computer performance of the recommendation pipeline.

In addition, traditional architectures tend to separate the scoring logic from the feedback loop. While some systems log user clicks or purchases, they do not systematically feed this information back into both (i) the underlying machine learning model that computes candidate item suitability and (ii) the prompt design strategy used to drive the generative AI model. As a consequence, the system cannot effectively refine its internal models or prompt configurations, resulting in suboptimal ranking quality, increased latency due to unnecessary or ineffective model calls, and an inability to computationally optimize the end-to-end pipeline.

There is therefore a need for a computer-implemented technique that structurally integrates (i) acquisition and feature extraction of detailed user attribute information and past user behavior information, (ii) real-time acquisition of user position information within a physical space, (iii) machine-learning-based suitability scoring of context-specific candidate items, and (iv) adaptive generation and updating of prompt sentences for a generative AI model, together with (v) a feedback mechanism that updates both the recommendation model and the prompt generation conditions. Such integration should improve computer functionality by enabling more accurate, context-aware selection of candidate items, more efficient invocation of generative AI models, and dynamic optimization of the overall recommendation process in response to accumulated behavioral data.

The specific processing by the specific processing unit 290 of the data processing device 12 in Application Example 1 is realized by the following means.

The present invention provides a server comprising a processor and a storage medium, the processor being configured to execute instructions to acquire, from the storage medium, user attribute information and past user behavior information, generate feature information representing a preference and an interest of a user based on the user attribute information and the past user behavior information, acquire, from a terminal, position information of the user in a physical space, and identify an area in which the user is present based on the position information, input the feature information and candidate item information associated with the area as input information to a machine learning model, calculate, by the machine learning model, a suitability score for each candidate item, and select one or more candidate items to be presented to the user based on the suitability score, generate a prompt sentence, based on the feature information, the position information, and attribute information relating to the selected one or more candidate items, the prompt sentence instructing a generative AI model to generate a natural language response to propose the selected one or more candidate items to the user, transmit, to the terminal, proposal information obtained from the generative AI model by inputting the prompt sentence, as notification information to be presented to the user, acquire, from the terminal, response information indicating a selection operation of the user with respect to the one or more candidate items included in the notification information, store the response information as behavior information of the user in the storage medium, and update at least one of the machine learning model and a generation condition of the prompt sentence based on the response information stored in the storage medium. This enables the server to computationally improve recommendation accuracy and system efficiency by tightly coupling machine-learning-based suitability scoring, real-time context acquisition, and adaptive prompt generation for a generative AI model, and by using user response information as feedback to continuously refine both the underlying model parameters and the prompt sentence configuration, thereby enhancing the overall performance of the computer-implemented recommendation pipeline.

The term “user attribute information” refers to information that characterizes a user in a relatively static manner, including but not limited to demographic data, profile data, stated preferences, and other user-related properties stored in a storage medium.

The term “past user behavior information” refers to information indicating actions previously performed by a user, including but not limited to item views, selections, purchases, navigation history, and responses to past recommendations, which are recorded in a storage medium.

The term “feature information” refers to data generated by processing user attribute information and past user behavior information into a structured representation, such as numerical values or categorical encodings, that can be input to a machine learning model.

The term “preference” refers to a tendency of a user to favor certain categories, characteristics, or attributes of items over others, as inferred from user attribute information and past user behavior information.

The term “interest” refers to a user's degree of attention or inclination toward particular topics, item categories, or content types, which can be inferred from user attribute information and past user behavior information.

The term “terminal” refers to an information processing apparatus operated or carried by a user, such as a mobile communication device, a portable computing device, or a fixed display device, that can communicate with a server and present information to the user.

The term “position information” refers to data indicating a current physical location of the user or the terminal in a physical space, which may be represented by coordinates, zone identifiers, section identifiers, or other spatial indicators.

The term “physical space” refers to a real-world environment in which the user is present, such as a commercial facility, a service facility, or another physical premises that can be subdivided into areas or sections.

The term “area” refers to a delimited portion of the physical space, such as a zone, section, aisle, or region, which can be identified based on position information and associated with one or more candidate items.

The term “candidate item information” refers to information related to one or more items that may be proposed to the user, including but not limited to identifiers, categories, attributes, price ranges, and availability, which is associated with a particular area.

The term “machine learning model” refers to a computational model that has been trained on data to learn relationships between input information and output values, and that can calculate outputs such as suitability scores when provided with feature information and candidate item information.

The term “suitability score” refers to a value calculated by the machine learning model that quantitatively represents a predicted degree of relevance, appropriateness, or preference of a candidate item for a particular user in a particular context.

The term “generative AI model” refers to a computational model, such as a language model, that generates output data, including natural language text, in response to input data, such as prompt sentences, according to parameters learned from training data.

The term “prompt sentence” refers to structured input text, optionally including instructions and contextual data, provided to a generative AI model to guide generation of an output, such as a natural language proposal of one or more candidate items to a user.

The term “natural language response” refers to text generated by the generative AI model in a human language, such as sentences or phrases, that can be presented to the user as an explanation, recommendation, or proposal.

The term “proposal information” refers to information derived from the natural language response of the generative AI model, optionally combined with item identifiers or attributes, which is transmitted from the server to the terminal for presentation to the user.

The term “notification information” refers to data structured for transmission to the terminal in a form suitable for user notification, such as a message payload containing proposal information, display content, and associated identifiers.

The term “response information” refers to data indicating how the user reacted to presentation of one or more candidate items, including but not limited to selection operations, non-selection, clicks, purchases, or dismissals, which is acquired from the terminal.

The term “selection operation” refers to an operation performed by the user via the terminal to indicate interest in, acceptance of, or interaction with one or more candidate items, such as selecting, viewing details of, or adding an item to a list or cart.

The term “behavior information” refers to information representing actions or reactions of the user, including response information and other interaction logs, which is stored in the storage medium and used for model updating or analysis.

The term “storage medium” refers to a physical or logical storage resource, such as a memory device, a database system, or a storage service, capable of storing user attribute information, past user behavior information, candidate item information, response information, and program instructions.

The term “generation condition of the prompt sentence” refers to configuration information, parameters, templates, rules, or other data that define how a prompt sentence is constructed, including which elements are included and how instructions to the generative AI model are expressed.

The term “update” refers to a process of changing, adjusting, or retraining at least part of the machine learning model or modifying the generation condition of the prompt sentence, based on newly obtained behavior information or response information.

The term “processor” refers to one or more hardware computation units, such as central processing units or other processing circuitry, that execute instructions to perform the functions described in the system.

In one embodiment, a server implements the claimed system by executing program instructions on one or more processors connected to a storage medium, a communication interface, and optionally an accelerator such as a graphics processing unit. The server executes an operating system and an application framework to provide network-accessible services to one or more terminals carried or operated by users. The server stores user attribute information, past user behavior information, candidate item information, model parameters, and configuration information for prompt sentences in one or more database systems.

The server uses a database management system, such as a relational database system, to store user records, behavior logs, and item catalogs in normalized tables. The server stores model parameters and feature statistics in a key-value store or an object storage system. The server uses a machine learning framework, such as a tensor-based numerical computation library, to implement and execute a recommendation model, and uses a generative AI interface library to invoke an external or internal generative AI model.

The server represents user attribute information as structured records containing fields such as age, general demographic group, broad interest categories, typical spending range, and account status. The server represents past user behavior information as event logs that include event type, timestamp, referenced item identifier, area identifier, and interaction result. The server encodes these events into higher-level aggregates such as category visit counts, recency values, and purchase frequencies. The server stores candidate item information as records including item identifier, category identifier, area identifier, price range, descriptive attributes, and stock status.

The server generates feature information by transforming the user attribute information and the past user behavior information into numerical vectors and categorical encodings. The server uses feature engineering procedures implemented in a data processing library. For example, the server maps categories, areas, and demographic groups to integer indices and then to dense vector embeddings; the server normalizes continuous values such as age and average purchase price using precomputed mean and variance values; and the server aggregates behavior logs into count features and time-decayed scores. By storing global statistics in the storage medium and reusing them for feature normalization, the server improves consistency and stability of the input distribution to the machine learning model, which in turn reduces error rates and improves convergence.

The server implements the machine learning model as a neural network architecture configured to compute suitability scores for candidate items. In one embodiment, the server uses a feedforward neural network comprising an embedding layer, one or more hidden layers with nonlinear activation functions, and an output layer that produces a scalar suitability score. The server maps categorical inputs, such as user interest category and item category, to embeddings through a lookup operation. The server concatenates user embeddings, item embeddings, and contextual features such as area identifiers into a single feature vector. The server applies fully connected layers with rectified linear unit activations and layer normalization to this feature vector. The server computes a suitability score for each candidate item as a continuous value between a minimum and maximum output range, and uses this score to rank candidate items.

The server trains the neural network model offline using stored behavior information. The server prepares training examples by pairing user feature vectors, context feature vectors, and item feature vectors with labels derived from response information, such as click or purchase indicators. The server defines a loss function, for example a cross-entropy loss for classification-like ranking, or a pairwise ranking loss such as a margin-based loss between positive and negative samples. The server computes gradients of the loss function with respect to the network parameters using backpropagation and updates the parameters by an optimization method such as stochastic gradient descent or an adaptive gradient method. The server may use data augmentation methods, such as sub-sampling of negative items and temporal weighting of recent interactions, to improve robustness. By structuring training in this manner, the server improves the predictive accuracy of suitability scores, thereby reducing the number of ineffective recommendations transmitted to terminals and improving computational efficiency by focusing generative AI calls on high-value candidates.

The server implements the generative AI model interface as a module that constructs prompt sentences and sends them to a large language model implementing a generative AI algorithm. The server may invoke an external network-based generative AI service or an on-premise language model executed on an accelerator device. The server does not treat the generative AI model as an opaque component; instead, the server explicitly controls model behavior through structured prompt sentences that encode feature information, contextual information, and selection conditions. By decoupling the construction of prompt sentences from the underlying generative engine, the server can systematically adjust the textual instructions to optimize latency, token usage, and response quality, thereby improving overall system throughput and reducing communication load.

The server generates the prompt sentence by combining a template with variable portions derived from feature information and candidate item information. The server stores one or more prompt templates in the storage medium, each template specifying a general instruction style, constraint description, and output formatting requirement. The server selects a template according to user segment, device capabilities, and current application context. The server then fills placeholders with user description, past behavior summary, current area description, budget limit, and a list of selected candidate items. The prompt sentence is thus structured as a concise, machine-determined instruction for the generative AI model.

For example, the server may generate a prompt sentence such as:
“The user is a 30-year-old office worker whose main hobby is running.

Based on past behavior, the user frequently selects sports-related items, especially running shoes, and typically chooses items priced around 100 units of currency.

The user is currently located in the sports section, in the running shoes aisle.

The following items have been selected as top candidates for this user:
1. Lightweight Running Shoes Model X, price 95 units of currency.
2. Cushioning Running Shoes Model Y, price 110 units of currency.
3. Stability Running Shoes Model Z, price 90 units of currency.

Using this information, please generate three concise product suggestions in natural language, explaining why each item matches the user's interests in sports goods and fits the user's budget.

Write the suggestions as if talking directly to the customer in a physical store, and keep each suggestion to one or two sentences.”

In another example, when feedback indicates that the user is price-sensitive and prefers very short messages, the server may generate a modified prompt sentence such as:
“The user prefers mid-range running shoes under 100 units of currency and values comfort and durability.

The user is in the running shoes aisle.

Recommend 2 or 3 running shoe models that clearly meet these criteria and explain in one short sentence per model why they are a good choice.

Use simple and direct wording and avoid technical jargon.”

The server uses these prompt sentences as input to the generative AI model, receives natural language responses, and extracts key portions for notification information. The server may apply post-processing rules to truncate overly long responses, remove extraneous disclaimers, and align terminology with stored item attributes. Because the server tightly constrains and systematically adjusts prompt content based on observed response information, the generative AI model outputs more focused proposals with fewer tokens, resulting in reduced processing time and bandwidth usage.

The terminal operates as an edge device that obtains position information and presents proposal information to the user. The terminal uses location-related hardware, such as wireless communication modules and proximity sensors, and uses an operating system location service to obtain signals from local infrastructure such as beacons or wireless access points. The terminal computes or receives a location identifier that corresponds to an area in a physical space and transmits this identifier to the server together with a user identifier. By performing this data acquisition and pre-processing locally, the terminal reduces the volume of raw signal data sent to the server and thereby reduces communication load.

The terminal receives notification information from the server, which includes a natural language proposal, item identifiers, and optional metadata. The terminal presents this information in a user interface as a notification or an in-application component. The terminal records user interactions, such as tapping on a recommended item, dismissing a notification, or confirming a purchase, and sends response information back to the server. The server stores these interactions in the storage medium and uses them as behavior information for model updates. As a result, the system can adapt not only to user content preferences but also to interaction modalities, enabling the server to optimize presentation formats and prompt content for different device types and network conditions.

The user operates the terminal by moving within the physical space, viewing displayed proposals, and performing selection operations on candidate items. The user's behavior, as represented by response information, forms the basis for updating both the machine learning model and prompt sentence generation conditions. Over time, the server tunes the selection criteria for candidate items, such as minimum suitability thresholds and diversity constraints, and adjusts prompt templates to emphasize aspects that historically yield higher engagement or satisfaction, such as emphasizing budget, comfort, or novelty.

The server integrates these modules into a structured data flow in which feature information, suitability scores, prompt sentences, and responses are linked through identifiers. For example, the server associates each recommendation cycle with a recommendation identifier that links the selected candidate items, the generated prompt sentence, the generative AI output, and the subsequent response information. This linkage allows the server to perform fine-grained evaluation of what combinations of features, items, and prompt configurations produce favorable user responses. Based on this analysis, the server updates prompt generation conditions in a non-conventional, data-driven manner rather than through static designer input. This design goes beyond mere automation of human writing and instead implements an adaptive computational mechanism that continuously optimizes how the generative AI model is used.

In another embodiment, the server implements the machine learning model as a factorization-based or sequence-based architecture. For example, the server may use a model that combines recurrent or attention-based layers to encode ordered behavior sequences. The server inputs a sequence of recent user interactions, encoded as item embeddings and time interval features, into a recurrent unit or a multi-head attention layer to capture temporal patterns in user behavior. The server concatenates the resulting sequence embedding with static attribute features and area embeddings to produce a context-aware user representation. By capturing temporal order and context in this way, the server improves prediction of immediate interests, which allows more accurate pre-filtering of candidate items and more targeted use of the generative AI model.

In a further embodiment, the server deploys the recommendation model and prompt generation logic across multiple nodes and uses a caching mechanism. The server may cache feature vectors and partial model outputs for users or areas that are frequently accessed. When the server receives new position information that does not substantially change the context, the server can reuse existing feature computations and update only a small portion of the input, thereby reducing processing time and computational load. This system-level optimization contributes to an improvement in the technical performance of the computer infrastructure, beyond merely implementing a business rule.

The server achieves technical effects by coordinating the machine learning model and generative AI model under a unified control strategy. By using suitability scores to limit candidate items before invoking the generative AI model, the server reduces the size of prompt sentences and decreases the number of model calls. This improves overall throughput and reduces resource consumption on both the server side and the generative AI side. At the same time, by updating the machine learning model and prompt generation conditions based on behavior information, the server gradually increases recommendation accuracy. Higher accuracy leads to fewer unnecessary notifications, which reduces network traffic between the server and terminals as well as reduces processing on the terminals. These improvements in processing efficiency, data management, and communication load constitute improvements to computer technology itself, rather than merely automating a human decision-making process.

The server also implements non-conventional processing rules that shape how the AI components are used. For example, the server defines a maximum token budget for each prompt sentence based on current system load and network conditions and dynamically selects which item attributes to include in the prompt. The server may drop less relevant attributes when the token budget is low, while preserving key attributes like price range and primary feature. The server monitors latency and adjusts sampling parameters for the generative AI model to trade off between response diversity and response time. These control rules are implemented algorithmically in the server and would be difficult to reproduce manually by a human operator in real time, demonstrating that the system provides more than a simple automation of human work.

The system may be implemented in various alternative configurations. In one variation, the generative AI model runs on the same physical machine as the server, using an accelerator to perform inference locally, which reduces dependency on external services and improves latency. In another variation, the recommendation model and the generative AI interface are implemented as separate microservices communicating over an internal network, allowing independent scaling and update. In yet another variation, the terminal performs part of the feature extraction or lightweight suitability scoring locally, sending only high-level summaries to the server. These variants all remain within the scope of the claimed system, provided that the processor is configured to perform the functional steps of generating feature information, scoring candidate items, generating and updating prompt sentences, and updating models based on response information.

Through these concrete architectural and algorithmic arrangements, the server, the terminal, and the user cooperate in a manner that tightly couples machine learning-based suitability estimation with generative AI-based natural language proposal generation. This integrated design, with explicit control of data structures, model architectures, and prompt sentence parameters, improves the technical operation of the computer system by increasing prediction accuracy, reducing computational and communication overhead, and providing a systematic feedback loop to refine both recommendation and language generation components.

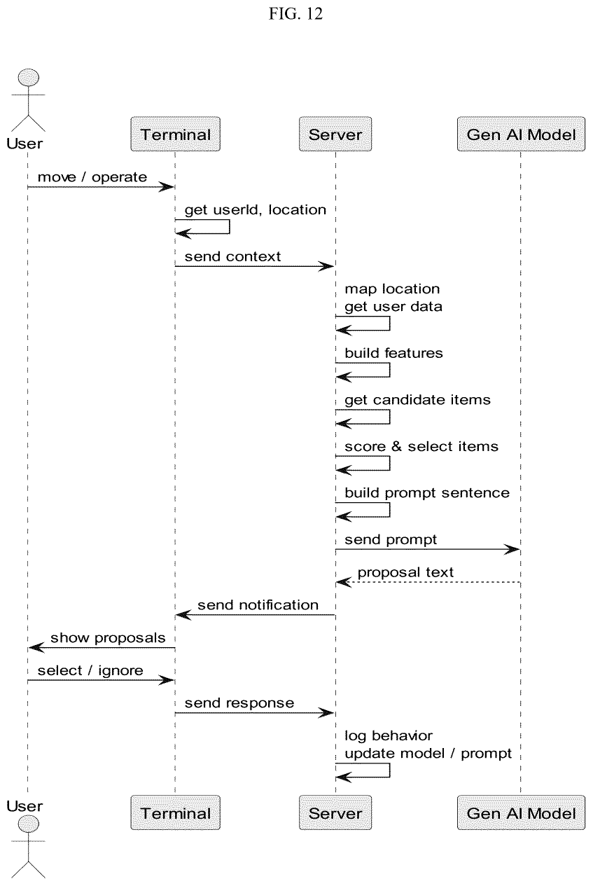

The following describes the processing flow using FIG. 12.

### Step 1

The terminal acquires user identification information and position information.

The terminal uses an operating system location service and local wireless hardware to scan for signals in a physical space, such as signals from proximity transmitters or wireless access points.

Input: raw radio signals, device identifiers, and previously stored user account information.

The terminal measures signal strength values, retrieves a user identifier from secure storage, and maps the raw signals to a location identifier representing an area, such as a section or aisle.

Output: a data structure including the user identifier, the location identifier, a timestamp, and device context information.

### Step 2

The terminal transmits the user identifier and the location identifier to the server.

The terminal constructs a network request containing the user identifier, the location identifier, and metadata, and sends this request to a predefined server endpoint over a secure communication channel.

Input: the user identifier, the location identifier, the timestamp, and device context from Step 1.

The terminal serializes this information into a structured payload and performs an encrypted network transmission.

Output: a network message delivered to the server containing current user context information.

### Step 3

The server receives the network message and identifies an area in a physical space.

The server parses the received payload, validates the user identifier and location identifier, and maps the location identifier to an internal area identifier using a stored mapping table.

Input: the structured payload transmitted by the terminal in Step 2 and a mapping table stored in a storage medium.

The server executes a lookup operation in the mapping table to convert the location identifier into a canonical area identifier, such as a normalized section code.

Output: a validated user identifier and a canonical area identifier that will be used in subsequent processing.

### Step 4

The server acquires user attribute information and past user behavior information from a storage medium.

The server accesses one or more databases using the validated user identifier to read profile records, historical event logs, and previous recommendation responses.

Input: the validated user identifier from Step 3 and database records stored in the storage medium.

The server executes query operations that retrieve demographic attributes, interest categories, spending ranges, item interaction logs, and previous response information.

Output: a set of raw user attribute records and raw behavior event logs associated with the user.

### Step 5

The server generates feature information representing user preferences and interests.

The server processes the raw user attribute information and past user behavior information to construct numerical and categorical feature vectors suitable for machine learning.

Input: the raw attribute records and behavior logs from Step 4, and pre-stored normalization parameters and encoding dictionaries.

The server maps categorical fields to indices, applies embedding indices or one-hot encodings, normalizes numeric fields using stored statistical values, and aggregates event logs into counts, recency scores, and time-weighted measures.

Output: a structured feature vector representing the user's preferences, interests, and behavior characteristics.

### Step 6

The server acquires candidate item information for the identified area.

The server queries an item catalog or service to obtain items associated with the canonical area identifier and filters them according to availability and other constraints.

Input: the canonical area identifier from Step 3 and a stored item catalog.

The server executes filtering operations on item records using the area identifier, stock status, and optionally business rules such as promotion flags or category constraints.

Output: a list of candidate item records, each including an item identifier, item attributes, and area association.

### Step 7

The server computes suitability scores for candidate items using a machine learning model.

The server uses the feature information and the candidate item information as inputs to a trained neural network or other machine learning model to calculate relevance for each candidate item.

Input: the user feature vector from Step 5 and the candidate item list from Step 6.

The server constructs input tensors by combining user features, area features, and per-item features, applies the neural network's forward computation, and obtains a suitability score for each item.

Output: a ranked list of candidate items with associated suitability scores.

### Step 8

The server selects one or more candidate items to present to the user.

The server sorts the candidate items based on suitability scores and applies additional selection rules, such as diversity constraints or threshold conditions, to determine which items to include in a recommendation.

Input: the ranked list of candidate items and suitability scores from Step 7, and stored selection rules.

The server discards items with low scores, resolves ties according to predetermined criteria, and selects a subset of items that best match the current context.

Output: a selected subset of candidate items with item identifiers and item attribute information.

### Step 9

The server generates a prompt sentence for a generative AI model.

The server constructs a natural language instruction that describes the user characteristics, the current area, and the selected items, and specifies how the generative AI model should generate a proposal.

Input: the user feature summary from Step 5, the canonical area identifier from Step 3, and the selected candidate items from Step 8, along with stored prompt templates and generation conditions.

The server fills template fields with user description, area description, budget indication, and concise item summaries, and produces a coherent prompt sentence.

Output: a text-based prompt sentence configured to instruct the generative AI model.

### Step 10

The server transmits the prompt sentence to the generative AI model and acquires a natural language response.

The server sends the generated prompt sentence to a generative AI interface and receives a generated text that proposes the selected items to the user.

Input: the prompt sentence from Step 9 and configuration parameters such as maximum length and sampling options.

The server forms a request containing the prompt sentence and parameters, delivers the request to the generative AI model, and receives the generated natural language response.

Output: a natural language response that includes item proposals, explanations, and any additional requested text.

### Step 11

The server generates notification information based on the natural language response.

The server formats the generative AI output into a structure suitable for transmission to the terminal, and associates each textual proposal with corresponding item identifiers.

Input: the natural language response from Step 10 and the selected candidate items from Step 8.

The server extracts titles, short descriptions, and key sentences, binds them to item identifiers and image references, and constructs a notification payload.

Output: notification information containing proposal text, item identifiers, and presentation metadata.

### Step 12

The server transmits the notification information to the terminal.

The server sends the structured notification payload over a communication channel so that the terminal can present the proposals to the user.

Input: the notification information from Step 11 and terminal address information derived from the user identifier.

The server packages the payload according to a messaging or notification protocol and performs a network transmission to the terminal.

Output: a delivered notification at the terminal side containing proposals and associated item data.

### Step 13

The terminal presents the notification information to the user.

The terminal receives the notification payload, parses its content, and renders a user interface displaying the proposed items and explanations.

Input: the notification information from Step 12.

The terminal extracts item titles, images, prices, and generated descriptions, arranges them into interactive interface elements, and displays them on a screen or other output device.

Output: a visual or auditory presentation of item proposals that the user can review and interact with.

### Step 14

The user performs a selection operation on one or more proposed items.

The user reviews the proposed items presented by the terminal and interacts with the interface to express interest, such as by selecting an item, opening details, or confirming a purchase.

Input: the displayed proposal information from Step 13.

The user performs explicit actions such as tapping, clicking, or pressing control elements associated with specific items.

Output: user interaction events indicating which items the user selected, rejected, or ignored.

### Step 15

The terminal generates and transmits response information to the server.

The terminal converts the user interaction events into a structured representation that describes the user's response to the proposals.

Input: the user interaction events from Step 14 and context information such as timestamps and current area.

The terminal constructs a response payload including the user identifier, item identifiers, action types, and timing data, and sends this payload to a designated endpoint of the server.

Output: a network message containing response information delivered to the server.

### Step 16

The server stores the response information as behavior information.

The server parses the response payload and records the response information in a behavior log or feedback table in the storage medium.

Input: the response information from Step 15 and existing behavior data stored in the storage medium.

The server validates the response data, transforms it into standardized event records, and appends these records to a behavior dataset linked to the user and the recommendation cycle.

Output: updated behavior information including new response events stored for future analysis and training.

### Step 17

The server updates at least one of the machine learning model and the generation condition of the prompt sentence.

The server uses the accumulated behavior information, including the newly stored responses, to adjust model parameters or configuration rules for prompt generation.

Input: the updated behavior information from Step 16, current model parameters, and current prompt generation conditions.

The server computes performance metrics, identifies patterns such as frequent positive responses to certain item types or message styles, and applies update procedures such as retraining or fine-tuning the machine learning model and modifying prompt templates or selection rules.

Output: an updated machine learning model and/or updated prompt generation conditions that reflect the observed user behavior and are used in subsequent execution of Steps 5 through 11.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional communication support systems that employ a generative AI model typically accept only raw message text from a user and return generic reply candidates without deeply utilizing stored user information or feedback. As a result, such systems often produce responses that are poorly aligned with a user's communication style, preferences, or constraints, and require the user to perform substantial manual editing. Moreover, conventional architectures generally treat each message in isolation and do not systematically exploit historical interaction data to improve future reply generation, leading to inefficient use of computational resources and degraded user experience.

In addition, typical server-side implementations invoke a generative AI model with ad hoc or static prompt sentences that are hand-crafted and not dynamically adapted to a particular user entity or communication context. This causes the generative AI model to perform redundant reasoning on user-specific constraints (such as budget, activity preferences, or tone) in every session, even though such constraints are already stored in backend data structures. Consequently, processing time and compute cost are increased, throughput is reduced, and the overall system fails to fully leverage available structured data.

Further, many existing systems lack a systematic mechanism to encode user behavior history into the prompt sentence supplied to the generative AI model. When the system does not incorporate the user's past selection history of reply candidates, the generative AI model cannot reliably converge toward a user-preferred style of responses. This results in repetitive generation of unsuitable replies, unnecessary additional inference calls, and wasted network bandwidth between the server and the terminal apparatus.

From a computer-technology perspective, there is therefore a need for an improved server-side control mechanism that efficiently combines structured user profile information, behavior history information, and real-time communication content analysis to construct optimized prompt sentences for a generative AI model. By optimizing the prompt construction process and closing the feedback loop between user actions on the terminal apparatus and server-side data structures, it becomes possible to reduce unnecessary computation, improve response relevance, and enhance the effectiveness of communication support in a resource-efficient manner.

The specific processing by the specific processing unit 290 of the data processing device 12 in Example 2 is realized by the following means.

The present invention provides a server comprising a processor and a storage apparatus, the processor being configured to acquire, from the storage apparatus, attribute information, preference information, and behavior history information relating to a user entity and to generate profile information of the user entity based on the attribute information, the preference information, and the behavior history information; to acquire communication content transmitted and received between user entities and to execute natural language analysis processing on the communication content so as to extract intention information and situational information of the communication content; to construct, on the basis of the profile information and the intention information, a prompt sentence for input to a generative AI model, the prompt sentence defining generation conditions of response information by the generative AI model; to input the prompt sentence to the generative AI model so as to cause the generative AI model to generate a plurality of response candidate information items for the communication content and to select, from generation results, response candidate information to be presented to the user entity; to transmit the selected response candidate information to a terminal apparatus and to cause the terminal apparatus to display the response candidate information in a form selectable by the user entity; and to acquire, from the terminal apparatus, selection result information relating to response candidate information selected by the user entity, or response information generated by editing the response candidate information, to store the selection result information as at least part of the behavior history information in the storage apparatus, and to reflect the selection result information in subsequent generation of the profile information and the prompt sentence. This enables the server to dynamically adapt the prompt sentence and resulting response candidates to the user entity's evolving preferences and behavior patterns, thereby improving computational efficiency and relevance of generated replies, reducing redundant processing by the generative AI model, and enhancing overall performance of the communication support system as a computer-implemented technology.

The term “user entity” refers to a human user or an organization that utilizes the system to exchange communication content and to receive response candidate information generated by the system.

The term “processor” refers to one or more hardware processing units, such as a central processing unit or a graphics processing unit, configured to execute instructions that implement functions of the system.

The term “storage apparatus” refers to one or more hardware storage units, such as a magnetic disk device, a semiconductor memory device, or a solid state drive, configured to store data including attribute information, preference information, behavior history information, and communication content.

The term “attribute information” refers to structured data describing basic characteristics of a user entity, including but not limited to demographic information, role information, and other static profile attributes.

The term “preference information” refers to data indicating choices, likes, dislikes, or desired conditions of a user entity, including but not limited to communication style, activity preferences, and budget-related preferences.

The term “behavior history information” refers to data representing past actions or selections of a user entity within the system, including but not limited to histories of selected response candidates, edited responses, and interaction patterns with communication content.

The term “profile information” refers to aggregate information generated for a user entity on the basis of attribute information, preference information, and behavior history information, and used to guide prompt construction and response generation.

The term “communication content” refers to message data exchanged between user entities, including textual messages, chat logs, or other natural language expressions that are input to the system for analysis and response generation.

The term “natural language analysis processing” refers to computational processing applied to communication content in human language, including but not limited to tokenization, parsing, entity extraction, intent classification, and contextual interpretation.

The term “intention information” refers to data indicating a communicative purpose or intent inferred from communication content, such as an invitation, request, question, confirmation, or notification.

The term “situational information” refers to contextual data inferred from communication content, including but not limited to temporal information, location-related information, relationship context between user entities, and activity type.

The term “generative AI model” refers to a machine-learned model configured to generate natural language output or other content in response to an input prompt sentence, including but not limited to large language models.

The term “prompt sentence” refers to an instruction expression, represented as a sequence of symbols or text, supplied to a generative AI model to define a task, constraints, or generation conditions for response information.

The term “generation conditions” refers to constraints, guidelines, or requirements specified in a prompt sentence that influence how a generative AI model generates response information, including desired style, tone, length, and content scope.

The term “response information” refers to natural language output generated by a generative AI model as a reply or candidate reply to communication content.

The term “response candidate information” refers to one piece of response information among a plurality of automatically generated proposed replies that can be presented to a user entity for selection.

The term “response candidate information items” refers to multiple pieces of response candidate information collectively generated by the generative AI model for a single item of communication content.

The term “proposal information” refers to generated information that includes, in addition to response information to communication content, suggested activities, constraints, or conditions such as budget constraints, dates, or locations.

The term “budget constraint information” refers to data describing monetary limits or price-related conditions associated with a user entity, used to influence generation of proposals or responses that respect such limits.

The term “activity preference information” refers to data indicating types of activities favored or disfavored by a user entity, such as preferences for entertainment, dining, travel, or other actions.

The term “communication style information” refers to data indicating a preferred manner of expression of a user entity, including but not limited to formality level, politeness, directness, or typical length of messages.

The term “selection history” refers to a subset of behavior history information indicating which response candidate information items were selected or rejected by a user entity in past interactions.

The term “writing style” refers to a pattern of linguistic expression, including aspects such as sentence structure, vocabulary choice, and level of formality, used in generated response information.

The term “tone” refers to an emotional or attitudinal characteristic of response information, such as friendly, polite, formal, casual, apologetic, or enthusiastic.

The term “terminal apparatus” refers to an information processing apparatus operated by a user entity, such as a mobile device, a tablet, or a personal computer, configured to send communication content to the server and display response candidate information.

The term “selection result information” refers to data indicating which response candidate information was chosen by a user entity, or how a response candidate information item was edited, and is used to update behavior history information.

The server implements the invention as a network-accessible communication support platform that cooperates with one or more terminals operated by users. The server uses a hardware configuration that may include a multi-core central processing unit, a graphics processing unit optimized for matrix operations, a main memory, and a non-volatile storage apparatus such as a solid state drive. The server runs a general-purpose operating system and an application framework that hosts multiple software modules, including a database management module, a natural language processing module, a prompt construction module, and a generative AI inference interface module.

The server stores, in the storage apparatus, attribute information, preference information, and behavior history information for each user. The server represents attribute information as records in a relational table structure, for example with fields such as user_id, age_group, role_category, and communication_formality_level. The server represents preference information as key-value pairs or as vectors, for example storing activity preferences (e.g., movies, outdoor activities, dining), budget ranges, and preferred answer types (e.g., concise, detailed, humorous). The server represents behavior history information as log records containing fields such as original_message_id, list_of_offered_reply_candidate_ids, selected_reply_candidate_id, and edit_distance_between_candidate_and_final_reply. By representing the data in this structured manner, the server can efficiently perform indexed retrieval and aggregation operations, thereby improving the speed and scalability of the system compared to unstructured log storage.

The server uses a natural language processing module to analyze communication content exchanged between users. The server loads a tokenization component, a part-of-speech tagging component, and a named-entity recognition component, which are implemented as trained neural networks or statistical models. The server converts a received message into a sequence of tokens, assigns part-of-speech tags to each token, and identifies entities such as time expressions (“this weekend”), activity terms (“go see a movie”), and relationship clues (e.g., “manager”, “friend”). The server then maps the analyzed content into an internal message-intent data structure that includes fields such as intent_type (e.g., invitation, request, question), detected_entities, and contextual_tags (e.g., business_context, casual_context).

The server utilizes a generative AI model as a multi-layer neural network, for example a transformer architecture having an embedding layer, a plurality of self-attention layers, and a final projection layer that outputs token probabilities. The server obtains a trained model whose parameters have been optimized using a large corpus of text with a language modeling objective, in which the generative AI model minimizes a cross-entropy loss function between predicted and actual next tokens. The server further adapts the generative AI model to the communication support domain by fine-tuning on a dataset of conversation pairs and reply examples, using supervised learning with gradient-based optimization. The server updates model weights according to backpropagation, where gradients are computed with respect to the loss and learning rates are scheduled to ensure stable convergence.

The server constructs a prompt sentence that encodes both the user profile information and the intent of the current message into a single text sequence supplied to the generative AI model. The server does not simply pass the raw message; instead, the server concatenates multiple segments in a predefined schema, for example:
“The user is a 25-year-old office worker who prefers casual but polite communication. The user often declines weekend invitations due to a busy schedule but tries to propose alternative dates. Please propose three natural and friendly reply messages to the following invitation from a friend: ‘Do you want to go see a movie this weekend?’ Output each reply on a separate line.”

The server generates this prompt sentence by an algorithm that selects profile fields, converts them into descriptive phrases, and attaches task-specific instructions. The server composes the sentence using templates and rule-based phrase selection, where rules control, for example, when to include budget constraints or when to specify relationship roles. This algorithmic prompt construction is non-trivial because the server prioritizes which profile elements to include based on relevance scores computed from earlier interactions. The server improves computational efficiency by encoding only the most informative user attributes, thereby reducing prompt length and inference time while preserving or improving reply relevance.

The server uses a different prompt sentence format for business-related messages, for example:
“You are an assistant that generates polite business reply messages in English. The user is an employee replying to a manager. Please propose three concise and respectful replies to the following message: ‘Can you send me the project report by tomorrow?’ Output each reply on a separate line.”

The server decides which format to apply by evaluating the message-intent data structure and the relationship context inferred from the communication content and user roles. In this manner, the server combines rule-based selection with learned classifiers, allowing the system to compute context-sensitive prompts that a human operator would not easily produce with the same consistency and speed.

The server monitors behavior history information to adapt future prompt sentences. The server calculates statistics such as frequency of accepted candidates by tone, typical reply length preferred by the user, and proportion of edited versus unedited replies. The server represents these statistics as numeric features and updates them incrementally when new selection result information arrives from the terminal. Based on these features, the server modifies the prompt sentence to include instructions such as “Use short sentences with about 15 to 20 words” or “Use a very polite tone and avoid slang expressions.” Because the server encodes these constraints explicitly in the text input to the generative AI model, the generative AI model can produce outputs that match user preferences more closely without requiring custom re-training for each user. This adaptive prompting reduces the number of model calls needed to obtain an acceptable answer, thereby enhancing throughput and lowering processing time per request.

The terminal acts as an interface device operated by the user. The terminal includes a processor, a display unit, an input unit such as a touch screen, and a communication interface. The terminal executes an application that presents a chat-like user interface, receives messages from communication services, and forwards message text and context information to the server. The terminal structures request data in a fixed format, including user identifiers and message identifiers, and transmits the data using a secure network protocol. The terminal receives response candidate information from the server and renders selectable options to the user. Because the server already filters and structures candidates, the terminal processing remains lightweight, allowing devices with limited computing resources to benefit from the system.

The user operates the terminal to select one of the response candidates or to edit a candidate. The user may, for instance, select a candidate reply such as “Sounds great! Which movie do you want to watch?” or revise it to “Sounds great! Which movie and what time?” The terminal detects the user's selection or editing operation and transmits this information back to the server. The server stores this selection result information as behavior history information, which then influences subsequent prompt construction. This feedback loop allows the server to learn user-specific reply patterns over time, including preferred politeness level, degree of detail, and willingness to propose alternative plans.

The server attains technical improvement by organizing the data flow and processing pipeline in a way that reduces redundant computation and network traffic. The server achieves this by: (i) separating user profile computation from per-message processing, so that stable preference features are precomputed and reused; (ii) compressing such features into compact textual instructions included in the prompt sentence instead of repeatedly recomputing or transmitting large feature vectors; and (iii) using behavior history information to refine prompts, which increases the likelihood that the first generated candidate set will satisfy the user, reducing the need for additional generation rounds. Consequently, the server shortens average end-to-end latency and reduces the number of tokens processed by the generative AI model, which directly lowers computational cost.

The server improves accuracy and consistency by explicitly encoding domain-specific constraints within the prompt sentence. For example, when the profile information includes budget constraint information, the server may construct a prompt sentence such as:
“The user is a university student with a limited budget who prefers casual and friendly messages. Please propose three natural reply options to the following invitation from a friend: ‘Do you want to grab dinner this Friday at a new Italian place?’ Include at least one option that suggests a cheaper alternative. Output each reply on a separate line.”

The server thereby causes the generative AI model to generate one or more replies that respect monetary constraints without separately implementing complex rule-based filters for prices. The combination of profile-driven prompt construction and learned generative behavior yields high-quality, context-appropriate responses with reduced need for manual tuning.

The server uses an architecture in which modules are logically separated: a profile generation module, a communication analysis module, a prompt construction module, a generative inference module, and a feedback integration module. The server implements each module as a set of functions with defined input and output data structures. For instance, the profile generation module outputs a profile object containing canonical fields, which the prompt construction module transforms into text phrases. This modular design enables optimization of each component independently, such as caching profile objects to reduce database queries, or optimizing the prompt construction algorithm to minimize token count while maximizing information content.

The server applies specific rules and heuristics, distinct from human heuristics, to control prompt length and composition. For example, the server may calculate an importance score for each profile attribute based on an information gain metric derived from past selection history. The server includes only attributes whose scores exceed a threshold, which reduces unnecessary description in the prompt. The server may additionally assign penalties to attributes that have not affected user selections historically, effectively pruning them from future prompts. These automated, data-driven rules exceed simple manual prompt editing and represent a technical optimization process that improves computational efficiency of the generative AI model execution.

The server can employ alternative implementations of the generative AI model. In one embodiment, the server uses a large language model hosted on a remote inference platform, accessed through an application programming interface. In another embodiment, the server hosts a smaller model locally, using a transformer neural network implemented with standard numerical computation libraries. The server may apply quantization or model distillation techniques to reduce model size and inference latency, thus enabling deployment on hardware with lower memory capacity. The server can adjust generation parameters such as temperature and maximum token count based on the type of communication content and user preferences, providing an additional dimension of control over output quality and computational load.

The server can also incorporate data augmentation methods during model training or fine-tuning, such as synonym replacement, paraphrasing, and back-translation, to create diverse examples of replies. The server trains the generative AI model to minimize an objective function that combines language modeling loss with a regularization term reflecting alignment with known “good” replies chosen by users. The server, during training, updates model weights according to gradients computed over mini-batches of examples, using a stochastic optimization method. These training-related operations allow the deployed generative AI model to generalize better to unseen communication contexts and to produce more reliable reply candidates for the runtime system.

The server provides technical benefits that go beyond mere automation of human reply drafting. The server optimizes data structures, prompt construction procedures, and interaction flows to reduce round-trip time between server and terminal, minimize the amount of text processed by the generative AI model, and increase the proportion of first-pass suggestions accepted by users. These improvements are rooted in how the server organizes and processes digital information within a computing system, leading to improved performance metrics such as reduced average latency, lower inference cost, and higher response alignment accuracy. By tightly coupling profile-based prompt construction, adaptive feedback integration, and structured communication analysis, the system enhances operation of the underlying computer technology rather than merely replacing a human's decision-making process.

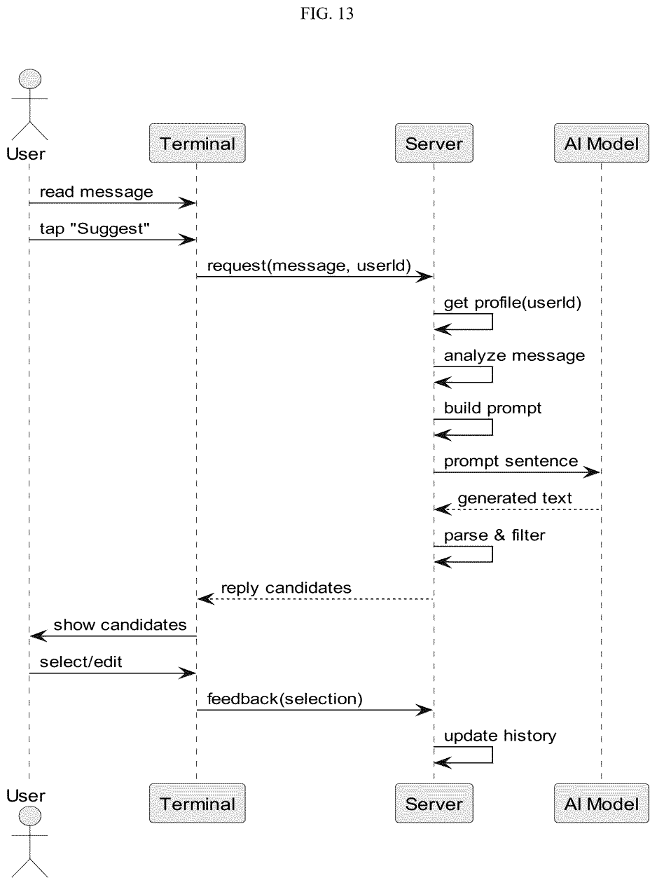

The following describes the processing flow using FIG. 13.

### Step 1

The user receives a message on the terminal.

The terminal displays the message in a conversation screen.

The input of Step 1 is message data delivered from an external communication service, including a sender identifier, a recipient identifier, a timestamp, and message text.

The terminal stores the message data in a local data structure or local storage and outputs a structured message record that can be referenced by later processing steps.

### Step 2

The user decides that a reply suggestion is needed and operates the terminal.

The terminal detects a user operation such as tapping a “Suggest reply” button associated with the received message.

The input of Step 2 is the structured message record selected by the user together with the user identifier maintained by the terminal.

The terminal packages the user identifier and the message text into a request object, performs data serialization to a formatted payload, and outputs a network request transmitted to the server via a communication interface.

### Step 3

The server receives the network request from the terminal.

The server validates the request by checking authentication information and structural integrity of the payload.

The input of Step 3 is the serialized request containing the user identifier and the message text.

The server parses the payload into internal variables, logs the request for auditing, and outputs a normalized request object that is suitable for subsequent profile retrieval and language analysis.

### Step 4

The server retrieves profile-related data for the user from the storage apparatus.

The server issues database queries to obtain attribute information, preference information, and behavior history information associated with the user identifier.

The input of Step 4 is the normalized request object that contains the user identifier.

The server performs indexed searches and relational joins across profile tables, aggregates the retrieved records, and outputs a profile object that includes fields such as demographic category, communication style preferences, activity preferences, and statistics derived from past selection history.

### Step 5

The server analyzes the message text as communication content.

The server executes a natural language processing pipeline that includes tokenization, part-of-speech tagging, and named-entity recognition on the message text.

The input of Step 5 is the message text contained in the normalized request object.

The server maps tokens to internal IDs, assigns grammatical roles, extracts entities such as time expressions and activity terms, and applies an intent classifier to compute probabilities for intent types, thereby outputting a message-intent object containing intent information, detected entities, and situational tags.

### Step 6

The server determines which profile elements and contextual features are relevant to the current message.

The server calculates relevance scores between elements in the profile object and fields in the message-intent object based on pre-defined weighting rules or learned parameters.

The input of Step 6 is the profile object and the message-intent object.

The server performs numerical operations such as weighted summation and threshold comparison to select only the most informative attributes, and outputs a reduced feature set that indicates which user preferences, constraints, and communication style parameters should be reflected in the prompt sentence.

### Step 7

The server constructs a prompt sentence for a generative AI model.

The server converts the reduced feature set into descriptive phrases and merges them with task-specific instructions and the original message text according to a template.

The input of Step 7 is the reduced feature set and the original message text.

The server performs string concatenation, placeholder replacement, and rule-based phrase insertion, and outputs a prompt sentence such as “The user is a 25-year-old office worker who prefers casual but polite communication. The user often declines weekend invitations due to a busy schedule but tries to propose alternative dates. Please propose three natural and friendly reply messages to the following invitation from a friend: ‘Do you want to go see a movie this weekend?’ Output each reply on a separate line.”

### Step 8

The server submits the prompt sentence to the generative AI model.

The server encapsulates the prompt sentence and generation parameters, such as maximum token length and temperature, into an inference request.

The input of Step 8 is the prompt sentence generated in Step 7.

The server transmits the request to the generative AI model execution environment, triggers forward propagation through the model's neural network layers, and outputs a generated text sequence representing one or more candidate replies.

### Step 9

The server parses and structures the output from the generative AI model.

The server segments the generated text into individual reply candidates by detecting line breaks, numbering, or separator patterns.

The input of Step 9 is the generated text sequence produced by the generative AI model.

The server performs text splitting, whitespace trimming, and format normalization, and outputs a list of response candidate strings that can be further evaluated and filtered.

### Step 10

The server evaluates and filters the response candidate list.

The server applies safety checks, content filters, and style consistency checks to the candidate strings.

The input of Step 10 is the list of response candidate strings from Step 9.

The server performs rule-based scanning for prohibited terms, computes similarity scores to past accepted replies, may discard or modify unsuitable candidates, and outputs a finalized candidate set with associated metadata such as tone labels and confidence scores.

### Step 11

The server prepares and sends a response to the terminal.

The server encapsulates the finalized candidate set and metadata into a structured response payload.

The input of Step 11 is the finalized candidate set with metadata.

The server serializes the data, attaches appropriate response codes and headers, and outputs a network response message that is transmitted back to the terminal via the communication interface.

### Step 12

The terminal receives the response message from the server.

The terminal deserializes the payload and reconstructs the list of response candidates and their metadata.

The input of Step 12 is the network response message containing serialized candidate data.

The terminal parses the structured data, maps each candidate to a UI element such as a button or list item, and outputs a user interface state in which multiple reply candidates are displayed in a selectable form.

### Step 13

The user reviews and selects or edits a reply candidate on the terminal.

The terminal detects the user's selection or editing operation via the input unit.

The input of Step 13 is the displayed set of candidates and any text modifications entered by the user.

The terminal updates the text field with the chosen or edited reply, prepares the final reply message for transmission to the communication partner, and outputs both the final reply text for sending and selection result data for feedback to the server.

### Step 14

The terminal sends feedback information about the user's choice to the server.

The terminal constructs a feedback payload containing identifiers of the original message, identifiers of the offered candidates, and an indication of which candidate was selected or how it was edited.

The input of Step 14 is the selection result data generated in Step 13.

The terminal serializes the feedback data, transmits it as a network request to a feedback endpoint on the server, and outputs a completed feedback transaction that can be recorded by the server.

### Step 15

The server updates behavior history information and profile statistics.

The server receives the feedback payload and extracts selection result information.

The input of Step 15 is the feedback payload containing the user identifier, original message identifier, and selection details.

The server writes a new record into a behavior history log, recalculates statistics such as preferred tone distribution and typical reply length, updates corresponding fields in the profile object, and outputs an updated profile representation that will be used in subsequent executions of the prompt construction algorithm.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented matching, recommendation, and dialog systems typically treat natural language understanding, recommendation logic, and response generation as separate subsystems connected by static and manually designed rules. In many implementations, a server executes fixed matching algorithms on user profile data, while separate dialog engines return template-based responses to user queries. Emotion analysis, if present at all, is often executed as an auxiliary classification step whose result is not deeply integrated with downstream decision logic. As a result, such systems exhibit several technical limitations.

First, existing systems frequently cannot adapt the behavior of core algorithms, such as matching or planning, in real time based on rich semantic intent and emotional state extracted from user communications. Profile attributes and behavior logs are often processed with simple filters or static scoring, without leveraging the expressive power of generative models to restructure or refine prompts and downstream responses. This leads to sub-optimal use of computing resources and degraded quality of machine-generated content, because the models receive underspecified or poorly contextualized input.

Second, conventional architectures generally pass raw or minimally processed user text into generative models, or rely on pre-defined prompt templates that do not incorporate dynamically derived structured data such as intent, constraints, and emotion. These approaches make it difficult for the computing system to consistently produce precise outputs for heterogeneous tasks such as electronic transaction assistance, interpersonal advice, activity planning, and customer-service dialog. The generative model is forced to perform both low-level interpretation and high-level reasoning, which increases processing variance and can increase computational load and latency.

Third, known systems typically lack a unified mechanism in the server for programmatically generating prompt sentences that encode heterogeneous technical directives to a generative model. For example, matching, communication support, advice generation, and payment-method suggestion are often handled by disparate components, each with its own ad hoc prompt design. This fragmentation impedes optimization of model usage, complicates caching and batching of model calls, and limits the ability to systematically adjust prompts based on feedback signals or emotion estimates.

Fourth, emotion recognition is frequently implemented as a side-channel classifier whose outputs are not used to directly modify structured inputs to a generative model or to re-rank generated candidates. In many deployments, facial expression or voice tone analysis produces a label that is merely displayed to a human operator, without being consumed by the computational pipeline that forms prompts or selects and adjusts machine-generated responses. Consequently, the overall system cannot fully leverage emotional context to improve the relevance and appropriateness of generated content, such as date plans or customer-service responses.

These limitations result in inefficient use of computing resources, increased response times, and reduced accuracy and personalization of automated responses. There is a need for an improved computer-implemented system and method in which a processor systematically (i) converts heterogeneous user data into structured representations, (ii) generates task-specific prompt sentences for a generative AI model based on those structured representations and emotion information, and (iii) adjusts matching candidates, advice contents, plans, or payment suggestions based on emotion, thereby improving the technical performance and effectiveness of the overall information processing pipeline.

The specific processing by the specific processing unit 290 of the data processing device 12 in Application Example 2 is realized by the following means.

The present invention provides a server comprising a processor configured to obtain attribute information, interest information, and behavior history information associated with a user; to analyze the obtained information to generate structured data representing a state of the user; to obtain communication content data including text data or audio data from a terminal device; to perform natural language processing on the communication content data to extract at least intent information and constraint information; to perform emotion analysis on at least one of the text data and the audio data to specify emotion information indicating an emotional state of the user; to generate, based on the structured data, the intent information, the constraint information, and the emotion information, a prompt sentence including instruction content for causing a generative information processing model to execute at least one operation selected from matching, provision of advice, generation of an activity plan, proposal of a payment method, generation of a customer-service response sentence, and generation of a communication-support sentence; to input the prompt sentence to the generative information processing model and obtain response text data generated by the generative information processing model; to adjust, based on the emotion information, at least one of a matching candidate, advice content, the activity plan, the payment-method proposal, and at least a part of the prompt sentence; and to generate output data including the response text data for transmission to the terminal device so that the response text data is displayed by the terminal device. This enables the server to integrate structured user state representation, natural language intent and constraint extraction, and emotion-aware prompt sentence generation into a unified computational pipeline, thereby improving the efficiency and accuracy of calls to the generative information processing model, reducing latency, and enhancing the technical quality and personalization of automatically generated responses for matching, dialog support, planning, and electronic transaction assistance.

The term “processor” refers to a hardware computing element, such as a central processing unit or a processing circuit, that executes machine-readable instructions to perform data acquisition, analysis, generation of prompt sentences, interaction with a generative information processing model, and generation of output data.

The term “user” refers to a human individual or an organization that interacts with the system via a terminal device by providing input data such as profile information, behavior history information, and communication content data, and that receives output data generated by the system.

The term “attribute information” refers to information representing basic characteristics of a user, including but not limited to age, gender, occupation, residence area, and other profile-related attributes, which are used by the processor to characterize the user.

The term “interest information” refers to information indicating preferences or areas of interest of a user, including hobbies, favored activities, favored categories of goods or services, and other preference-related indicators, which are used by the processor in analysis and recommendation.

The term “behavior history information” refers to information indicating past actions of a user within one or more applications or services, including, for example, selection operations, browsing history, message sending history, reaction operations, and transaction history, which are used by the processor to infer tendencies and patterns of the user.

The term “structured data” refers to data in a machine-processable format, such as key-value pairs, records, or objects, that represent a state of a user, and that are generated by the processor based on attribute information, interest information, behavior history information, and analysis of communication content data.

The term “communication content data” refers to information representing communication between a user and the system or between users, including text messages, chat logs, queries, and other natural-language content, which are acquired from a terminal device.

The term “text data” refers to character-based data representing natural-language content input by a user or generated by the system, including sentences, phrases, and symbols.

The term “audio data” refers to time-series data representing sound signals associated with a user, including spoken utterances and voice tones that are captured by an audio acquisition device and processed by the processor.

The term “emotion information” refers to information indicating an estimated emotional state of a user, such as happiness, sadness, anxiety, anger, or calmness, which is determined by the processor through emotion analysis of text data, audio data, or facial expression information.

The term “emotion analysis” refers to computational processing performed by the processor to infer an emotional state of a user based on input data such as text data, audio data, or image-based facial expression information, including classification or regression using a machine learning model or an external emotion analysis service.

The term “intent information” refers to information indicating a purpose or goal of a user message, such as requesting advice, requesting a transaction explanation, requesting a date plan, or requesting a reply suggestion, which is extracted by natural language processing of communication content data.

The term “constraint information” refers to information representing conditions or limitations expressed by a user, such as budget values, time limits, preferred locations, or other restrictions, which are extracted by natural language processing and used to condition generation by a generative information processing model.

The term “generative information processing model” refers to a machine learning model configured to generate natural-language text or other content in response to an input sequence, including but not limited to a neural network-based language model, which receives a prompt sentence and outputs response text data.

The term “prompt sentence” refers to a natural-language or structured instruction sequence generated by the processor and provided as input to the generative information processing model, the instruction sequence encoding at least contextual information, intent information, constraint information, and optionally emotion information, and specifying a task to be executed by the generative information processing model.

The term “response text data” refers to natural-language text generated by the generative information processing model in response to a prompt sentence, and acquired by the processor for use as advice, activity plans, answers, customer-service responses, or communication-support sentences.

The term “matching” refers to a computational process in which the processor, based on structured data representing a user's state, identifies and ranks candidate entities, such as other users, items, events, or services, that are estimated to be suitable for the user.

The term “matching candidate” refers to an entity selected or ranked by the processor as a potential match for a user, where the entity may be another user, an item, a service, or an activity, and where the selection or ranking can be adjusted based on emotion information.

The term “advice” refers to guidance text or recommendations generated by the system for a user, including suggestions regarding interpersonal relationships, communication strategies, or behavioral choices, and output as response text data.

The term “activity plan” refers to structured or semi-structured content generated by the system that describes one or more proposed actions, such as date plans, leisure plans, or daily schedules, including details such as locations, time frames, and approximate costs.

The term “payment method” refers to a mode of performing an electronic settlement, including, for example, credit card payment, electronic wallet payment, prepaid card payment, or point-based payment, which can be proposed or selected by the processor.

The term “proposal of a payment method” refers to a computational operation in which the processor selects one or more candidate payment methods based on user state and emotion information and generates explanation text recommending the selected payment methods.

The term “customer-service response sentence” refers to response text data generated by the system for supporting interactions between staff and customers, including explanations, apologies, and alternative offers, which may be displayed on a terminal device used by a staff member.

The term “communication-support sentence” refers to response text data generated by the system to assist a user in composing or improving messages, including suggested reply sentences and conversation-continuation tips.

The term “terminal device” refers to an electronic device operated by a user or staff member, such as a mobile terminal, a wearable terminal, or a desktop terminal, which is configured to transmit input data to the server and display output data received from the server.

The term “imaging device” refers to a hardware component included in a terminal device that acquires image data, such as a camera configured to capture facial images or video of a user.

The term “audio acquisition device” refers to a hardware component included in a terminal device that acquires audio data, such as a microphone configured to capture voice or environmental sound.

The term “output data” refers to data generated by the processor for transmission to a terminal device, the data including at least response text data and optionally additional metadata, and being suitable for presentation in a user interface.

The term “natural language processing” refers to computational processing applied to text data by the processor, including tokenization, morphological analysis, part-of-speech tagging, syntactic analysis, and semantic interpretation, to extract intent information, constraint information, or other structured representations.

The term “state of the user” refers to a representation generated by the processor that characterizes a user at a certain time, including one or more of attribute information, interest information, behavior history information, intent information, constraint information, and emotion information.

In one embodiment, a server cooperates with one or more terminals operated by users to implement the claimed system. The server comprises at least one hardware processor, a memory, a network interface, and non-transitory storage. The terminal comprises at least one hardware processor, a memory, a display, an input interface (for example, a touch panel or keyboard), a microphone as an audio acquisition device, and, in some variants, a camera as an imaging device. The server and the terminal communicate over a network, such as a packet-switched network using a standardized transport protocol.

The server stores machine-executable instructions that, when executed by the processor, cause the processor to perform acquisition, analysis, prompt sentence generation, interaction with a generative AI model, and generation of output data. The server stores user-related data in a structured database, such as a relational database or a key-value store. The user-related data includes attribute information, interest information, and behavior history information, each organized as records that contain fields for respective elements. For example, attribute information is stored in records having fields for age, gender, occupation, and region; interest information is stored in records containing normalized identifiers for categories of content; and behavior history information is stored as time-stamped events representing selections, message exchanges, and transaction operations.

The server uses natural language processing software, such as a general-purpose NLP library, to process text data. The server uses tokenization modules, part-of-speech taggers, and dependency parsers to convert unstructured text strings into token sequences and parse trees. Each token is represented as a feature vector that includes a token identifier, a part-of-speech tag, and contextual embedding values. The server uses these feature vectors as inputs to higher-level classifiers for intent and constraint detection. For example, the server uses a trained classification model, which may be implemented as a neural network with an embedding layer, one or more recurrent or transformer layers, and a final softmax output layer, to assign an intent label to each user utterance.

The server uses an emotion analysis module to generate emotion information from text data, audio data, or image data. In one embodiment, the server implements the emotion analysis module as a multilayer neural network that accepts as input either text embeddings, acoustic feature vectors, or facial feature vectors. The server derives text embeddings from a trained language model, acoustic feature vectors from short-time spectral analysis of the audio signal, and facial feature vectors from a convolutional network applied to facial image patches. The server uses a loss function such as cross-entropy during training to optimize weight parameters for predicting discrete emotion classes (for example, happiness, sadness, anxiety). The server updates the weights using a gradient-based optimization algorithm during a prior training phase executed on training data. At runtime, the server performs only inference using the trained weights.

The server uses a generative AI model as a generative information processing model for generating natural-language responses. In one embodiment, the server uses a transformer-based language model with multiple self-attention layers, where each layer applies attention operations and feed-forward operations to sequences of token embeddings. The server represents an input prompt sentence as a sequence of token identifiers drawn from a predefined vocabulary. The model converts token identifiers to embedding vectors and iteratively updates internal hidden states across layers. The model outputs, for each time step, a probability distribution over the vocabulary. The server samples or selects tokens from these distributions according to configurable parameters, such as temperature and top-k or nucleus sampling thresholds, and concatenates selected tokens to form response text data.

The server constructs a prompt sentence by concatenating natural-language segments that encode structured data about the user, extracted intent information and constraint information, and emotion information. The server thereby creates an input sequence that more precisely specifies the requested task, such as matching, advice generation, activity planning, or payment method proposal. By structuring the prompt sentence in this way, the server causes the generative AI model to operate on higher-quality, more constrained input, which reduces the search space of candidate outputs and improves convergence of the generation process. This operation is not merely an automation of human drafting of prompts, but a systematic computational transformation from multi-modal user state data to a machine-optimized instruction sequence.

For example, when a user enters the message:
“Recently, I am having trouble figuring out how to ask someone out on a date.”

the server analyzes the message using the natural language processing module, assigns the intent information “request_dating_advice”, and identifies no explicit numeric constraints.

The server also uses the emotion analysis module to classify the emotion as “anxious”. The server generates a prompt sentence such as:
“A user says in Japanese: ‘Recently, I am having trouble figuring out how to ask someone out on a date’.
The intent is to request dating advice and the user feels anxious.
Please generate a friendly, empathetic reply in Japanese with three practical examples of how to invite someone on a date.”

The server provides this prompt sentence to the generative AI model. The generative AI model, running on server hardware that may include a graphics processing unit to accelerate matrix multiplications and attention calculations, generates response text data containing example invitation phrases. The server then stores the generated advice in the database as part of the user's interaction history and transmits the advice to the terminal for display.

In another example, when a user requests a plan with a constraint, such as: “I want to plan a date where I can enjoy nature with a budget of 5,000 yen.” the server recognizes the intent information “request_activity_plan” and extracts the constraint information “budget: 5000” and “theme: nature”. The server optionally uses geographic parameters stored as attribute information or obtained from the terminal's location sensors to infer a candidate region. The server generates a prompt sentence such as:
“A user wants to plan a date in Japan with a budget of 5000 yen and wants to enjoy nature. Please propose two or three realistic date plans in Japanese, including approximate costs and short descriptions.”

The server inputs this prompt sentence to the generative AI model. The model produces an output containing several candidate date plans, for example, a picnic in a nearby park and a short hike on a local trail. The server parses the generated output into distinct plan items using rule-based patterns and stores each plan item as a record with fields for name, description, estimated cost, and category. The server transmits structured plan data and the original natural-language description to the terminal.

In another embodiment, the server uses behavior history information, such as counts of likes sent to other users and aggregate statistics of message exchanges, to construct feature vectors that represent long-term user tendencies. The server combines these feature vectors with attribute information and interest information to compute similarity scores between the user and candidate entities. The server uses algorithms such as matrix factorization or neural collaborative filtering to obtain initial ranking scores. The server then adjusts these scores based on emotion information. For example, when the user expresses loneliness or sadness, the server increases the weight of candidates that historically respond more frequently or more empathetically, as inferred from conversation statistics. This adjustment is executed using numerical operations on vectors and scalar weights. The server thereby re-ranks matching candidates before generating a prompt sentence for the generative AI model.

In one example of matching, the server generates a prompt sentence that instructs the generative AI model to explain to system developers or operators how to adjust matching strategies, such as:
“Explain, in technical terms, how to adjust dating service recommendations when a user feels lonely, using behavior logs to avoid overwhelming the user. Provide a step-by-step description.”

The generative AI model outputs textual guidelines that the server can store as configuration documentation or use to derive new algorithmic parameters. This use of the generative AI model assists in designing internal system rules and does not merely output end-user dialog.

In a further embodiment, the terminal is implemented as smart glasses that include an imaging device and an audio acquisition device. The terminal captures a customer's facial expressions and voice while the user is working as store staff. The terminal compresses video frames and audio segments and transmits them to the server. The server extracts facial landmarks using a convolutional neural network and extracts spectral features from audio using a short-time Fourier transform. The server applies a trained emotion classification network to these features to obtain emotion information such as “disappointed” or “angry”.

The server then generates a prompt sentence such as:
“A customer in a retail store says: ‘This product is more expensive than I expected’, and the emotion is classified as disappointed.
Please generate three brief, polite Japanese responses a clerk could say, including one suggestion of a cheaper alternative and one mention of an applicable discount.”

The server inputs this prompt sentence to the generative AI model and obtains response text data that includes suggested utterances. The server sends these suggestions to the terminal, where the smart-glasses display overlays the text in the staff's field of view. The terminal thus functions as a real-time output device for machine-generated guidance. This combination of real-time emotion recognition and generative guidance, integrated through dynamically created prompt sentences, improves the responsiveness and appropriateness of human-machine collaboration compared to conventional template-based cue systems.

The server improves computational efficiency by separating the stages of interpretation and generation and by feeding high-level structured data into the generative AI model. The server performs intent and constraint extraction before invoking the generative AI model, thereby reducing the complexity of the task given to the model and lowering the number of tokens needed in each prompt sentence. The server also uses emotion information to adjust ranking and filter candidate outputs, which limits the search space for appropriate responses. As a result, the system can reduce average inference time and token usage compared to approaches that feed raw conversation history into the generative model without pre-processing.

The server further improves accuracy by using emotion information as an additional conditioning signal. The server not only recognizes emotion but also embeds explicit emotion descriptors in prompt sentences. By doing so, the generative AI model receives an enriched context that allows it to generate responses that better match the user's current psychological state. For example, the server feeds phrases such as “the user feels anxious” or “the user feels sad” into the prompt sentence. Experimental evaluations may show that the inclusion of such explicit emotion descriptors lowers error rates in task success measures, such as user-rated appropriateness or adherence to requested constraints.

The server also improves data management by storing structured representations of prompt sentences and response text data along with associated metadata. The server maintains records of which structured data elements were used to build each prompt sentence and logs the output of the generative AI model. This logging enables later analysis and adaptation, such as updating the mapping between emotion labels and ranking weights or adjusting the template fragments used in prompt sentence generation. By modeling prompts and outputs as first-class structured data elements, the server can batch requests, cache frequently used prompt fragments, and selectively reuse optimized instruction sequences, thereby further reducing communication load and processing overhead.

In one alternative embodiment, the server hosts the generative AI model locally, rather than accessing an external model over a remote interface. In this case, the server executes matrix multiplication operations and attention operations on specialized accelerators, such as general-purpose graphics processing units or dedicated neural processing units. The server can adjust model parameters such as the number of layers, the width of attention heads, and dropout rates to trade off between latency and generation quality. The server may fine-tune the model using domain-specific conversation logs and prompts, employing a loss function that combines next-token prediction loss with auxiliary losses for constraint adherence or emotion consistency. The server uses mini-batch gradient descent with an optimizer such as Adam to update model weights during the training phase. This configuration allows tighter integration between prompt sentence design and model architecture, and may further enhance technical performance.

In another variant, the server employs separate generative AI models for different tasks, such as one model specialized for transaction assistance and another specialized for relationship advice. The server selects which model to use based on the intent information extracted from the user's message. The server uses distinct prompt templates and decoding parameters for each model to match the requirements of each domain. This modular arrangement enables the server to allocate tasks to models with different capacities or domain training, improving both computational efficiency and response appropriateness.

The terminal uses the output data provided by the server to render user interfaces that are specific to the task type. For example, when the server generates advice for electronic transactions, the terminal displays the advice in a support dialog screen. When the server generates an activity plan, the terminal displays the plan in a structured card format that includes headings for location, schedule, and expected cost. When the server provides customer-service responses to smart-glasses, the terminal displays them as short text lines with minimal visual clutter, suitable for quick reading during in-person interaction.

The user interacts with the system by entering text, speaking into the microphone, and optionally providing explicit feedback, such as ratings or selections. The terminal encodes these interactions in a defined data structure and transmits them to the server. The server incorporates feedback signals into subsequent operations, for example by updating behavior history information and using changed behavior to influence future ranking and prompt sentence selection. This feedback loop allows the system to adapt to the user's evolving preferences and supports continual refinement of the computational pipeline.

Across these embodiments, the server applies a set of non-conventional, technical procedures that integrate structured data analysis, emotion-aware conditioning, and generative AI invocation through programmatically constructed prompt sentences. The described architecture and processing steps provide specific improvements to computer technology, including reduced token counts per model invocation, lower model variance due to better constrained prompts, improved accuracy in matching and advice tasks through multi-modal conditioning, and more efficient data management via structured logging of prompt-response pairs. The system thus goes beyond mere automation of human advisory work and instead implements a particular configuration of hardware and software components, data structures, and algorithmic flows that enhance the operation of the computing apparatus itself.

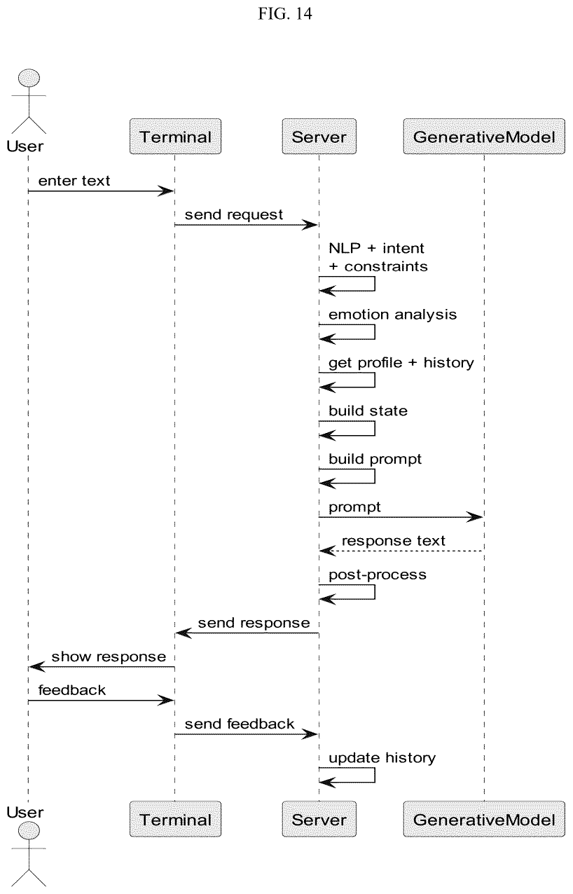

The following describes the processing flow using FIG. 14.

### Step 1

User operates the terminal to input natural-language content such as a question, a concern, or a request (for example, “Recently, I am having trouble figuring out how to ask someone out on a date.” or “I want to plan a date where I can enjoy nature with a budget of 5,000 yen”).

Input: raw text typed or spoken by the user.

Terminal converts spoken input to text when necessary using a speech-to-text component, attaches metadata (user ID, timestamp, device type, optional location), encapsulates the data in a request message, and transmits the request message to the server over a network connection.

Output: structured request data including user text and metadata sent to the server.

### Step 2

Server receives the request data from the terminal via a network interface and verifies basic integrity (for example, presence of user ID, non-empty text).

Input: request message containing user text and metadata.

Server stores the raw text in temporary memory, logs an entry in a request log table, and normalizes the text encoding. Server outputs the normalized text and associated identifiers into an internal data structure for further analysis.

Output: normalized text string and associated request context stored in server memory.

### Step 3

Server applies a natural language processing pipeline to the normalized text to extract tokens, parts of speech, and syntactic relations.

Input: normalized text string.

Server uses an NLP library to perform tokenization, morphological analysis, and dependency parsing, thereby converting the text into a sequence of tokens with linguistic tags. Server then feeds token features into an intent classification model and a constraint extraction module to derive intent information (for example, “request_dating_advice”, “request_activity_plan”, “request_transaction_help”) and constraint information (for example, “budget: 5000”, “theme: nature”).

Output: structured linguistic representation, intent information, and constraint information.

### Step 4

Server performs emotion analysis on the user's input and, when available, on audio or image data received from the terminal.

Input: user text, and optionally audio features and facial image features.

Server converts text into embeddings using a trained embedding model and computes acoustic or visual features via signal processing and convolutional layers. Server inputs these features into an emotion classification network and computes a probability distribution over predefined emotion classes, then selects the highest-probability class as emotion information (for example, “anxious”, “sad”, “relaxed”).

Output: emotion information indicating the user's estimated emotional state.

### Step 5

Server retrieves user profile information, interest information, and behavior history information from a database using the user ID in the request context.

Input: user ID and database connection.

Server executes queries to obtain profile records (age, gender, occupation, region), interest records (categories of interest), and behavior records (likes, messages, transaction logs).

Server aggregates these records into a unified user state object and encodes relevant elements as numerical or categorical features.

Output: structured user state data including attribute information, interest information, and behavior history information.

### Step 6

Server generates structured data representing the current state of the user by combining the user state data with intent information, constraint information, and emotion information.

Input: user state data, intent information, constraint information, emotion information.

Server constructs a structured object containing fields such as “intent”, “constraints”, “emotion”, and “long-term_preferences”, and may compute additional derived features, such as similarity scores to predefined templates or clustering labels. Server performs data fusion operations (for example, concatenation and normalization of feature vectors) to produce a single state representation.

Output: consolidated structured data object describing the user's current and historical state.

### Step 7

Server determines a task type to be executed by the generative AI model based on the intent information and the structured data object.

Input: structured data object and predefined mapping rules or classifier for task selection.

Server compares the intent against rule tables or applies a small classifier to decide whether the task is matching, advice generation, activity planning, payment-method proposal, customer-service response, or communication-support reply.

Output: task type identifier specifying which operation the generative AI model should perform.

### Step 8

Server constructs a prompt sentence for the generative AI model by programmatically assembling natural-language segments that encode the structured data and task type.

Input: structured data object and task type identifier.

Server inserts explicit descriptions of the user's request, constraints, and emotion into predefined prompt templates. For example, server generates a prompt sentence such as: “A user says in Japanese: ‘Recently, I am having trouble figuring out how to ask someone out on a date’. The intent is to request dating advice and the user feels anxious. Please generate a friendly, empathetic reply in Japanese with three practical examples of how to invite someone on a date.”

Server concatenates template fragments and variable content into a single string while enforcing length limits and sanitizing special characters.

Output: complete prompt sentence string ready for input to the generative AI model.

### Step 9

Server adjusts ranking weights or candidate sets, when matching or selection is involved, based on the emotion information before or during prompt sentence generation.

Input: emotion information and preliminary candidate data (for example, candidate matches, candidate payment methods, or candidate plans).

Server computes adjusted scores using a numeric function that modifies original scores with emotion-dependent weights (for example, increasing weights for supportive partners when the user is lonely). Server may embed descriptions of these adjustments into the prompt sentence, such as mentioning that the user currently wishes to save money.

Output: adjusted candidate list and, optionally, enriched context text for inclusion in the prompt sentence.

### Step 10

Server submits the prompt sentence to the generative AI model and initiates inference.

Input: prompt sentence string and model configuration parameters (for example, maximum token count, temperature).

Server converts the prompt sentence into token IDs according to the model's vocabulary, transfers the token IDs to the inference engine, and triggers forward passes through the transformer layers. The model computes attention weights and outputs probability distributions over tokens at each step. Server decodes the distributions into a sequence of tokens representing response text data.

Output: raw response text data generated by the generative AI model.

### Step 11

Server post-processes the response text data to ensure consistency with constraints, safety policies, and display format.

Input: raw response text data and structured data object.

Server analyzes the generated text to confirm language type and checks for adherence to constraints such as budget or requested number of examples. Server may re-invoke the generative AI model with a refined prompt sentence if hard constraints are violated, or perform rule-based edits to remove disallowed content. Server formats the final text (for example, adds bullet markers or short headings) according to the task type.

Output: validated and formatted response text data.

### Step 12

Server creates output data to be transmitted to the terminal, embedding the response text data and any associated structured information such as itemized plans or ranked candidates.

Input: validated response text data, adjusted candidate list, and task type.

Server encapsulates these components into an output message with fields that indicate how the terminal should present them (for example, “display_style: chat_bubble” or “display_style: card_list”). Server logs associations between the prompt sentence and the final output for traceability and future optimization.

Output: output message containing response text data and presentation metadata.

### Step 13

Terminal receives the output message from the server and parses its contents to identify the response text data and display instructions.

Input: output message transmitted from the server.

Terminal extracts the response text, determines the appropriate user interface element (for example, message bubble, advice panel, or list of plans), and updates the display. In the case of smart glasses, terminal renders a concise text overlay in the user's field of view.

Output: updated user interface that presents the generated response to the user.

### Step 14

User views the displayed response or suggestions on the terminal and may interact with them by selecting an option, following advice, or providing feedback such as a rating or preference update.

Input: displayed content and user actions (taps, clicks, voice commands).

Terminal captures the user's interactions as structured feedback events and transmits them to the server, where they are appended to the behavior history information.

Output: new feedback and behavior history entries transmitted to the server.

### Step 15

Server incorporates the feedback into the user's behavior history and updates internal parameters or statistics used for future prompt sentence generation and candidate adjustment.

Input: feedback events and existing behavior history information.

Server writes new events into the database and may recompute user-specific statistics, such as response acceptance rates or preferred plan types. Server uses these updated statistics to refine future ranking weights and to select more effective templates or fragments when constructing prompt sentences.

Output: updated user behavior history and configuration data that influence subsequent processing cycles.

The data generation model 58 is a so-called generative artificial intelligence (AI).

Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

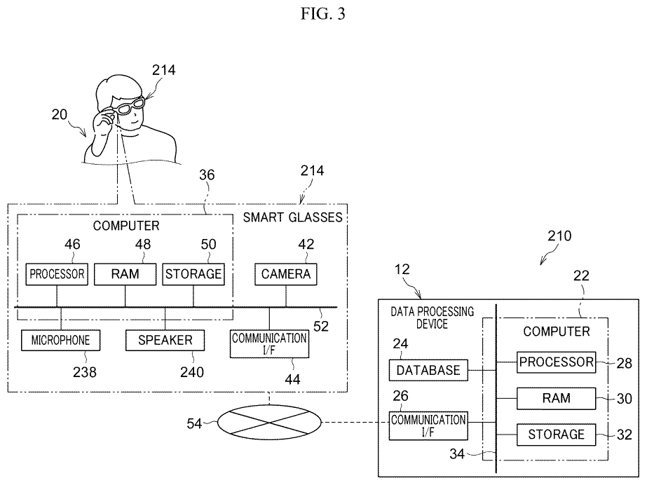

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

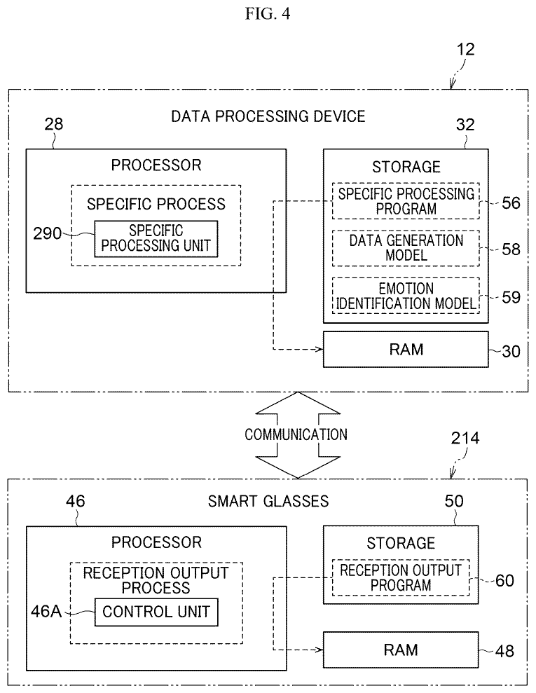

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

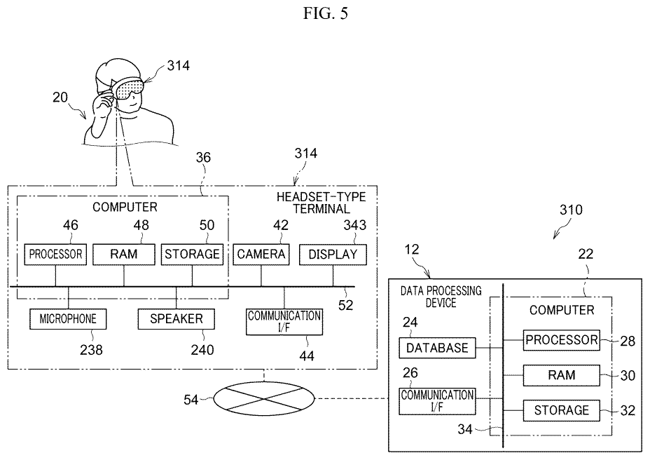

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

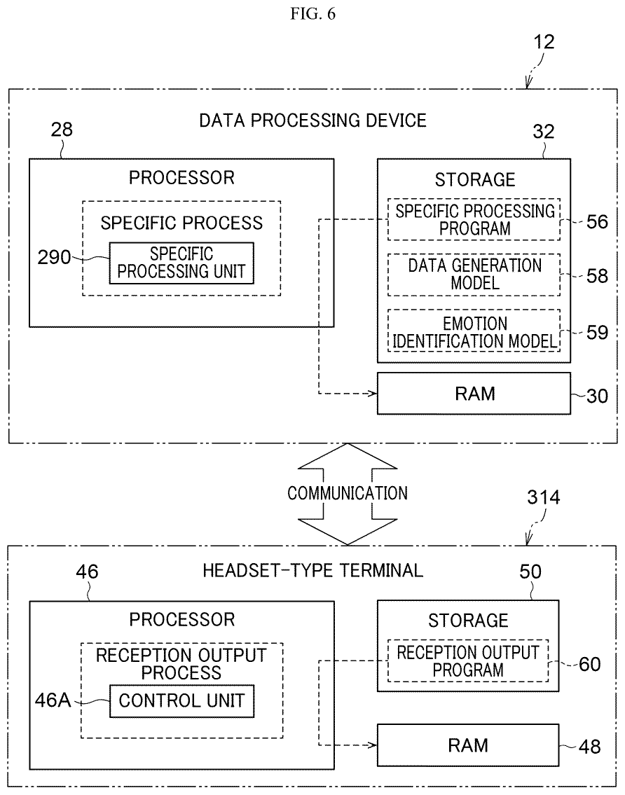

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

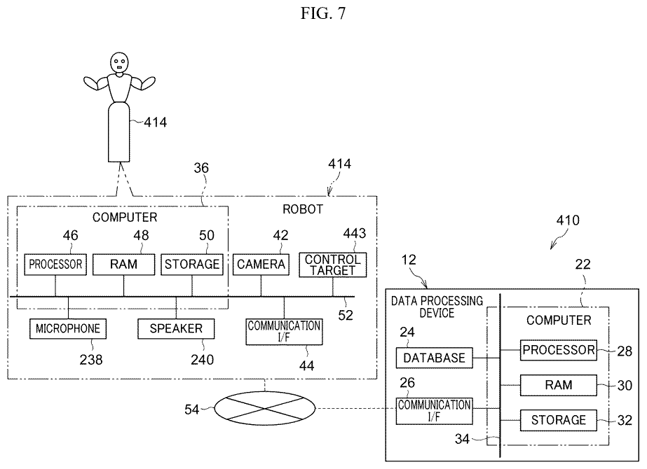

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

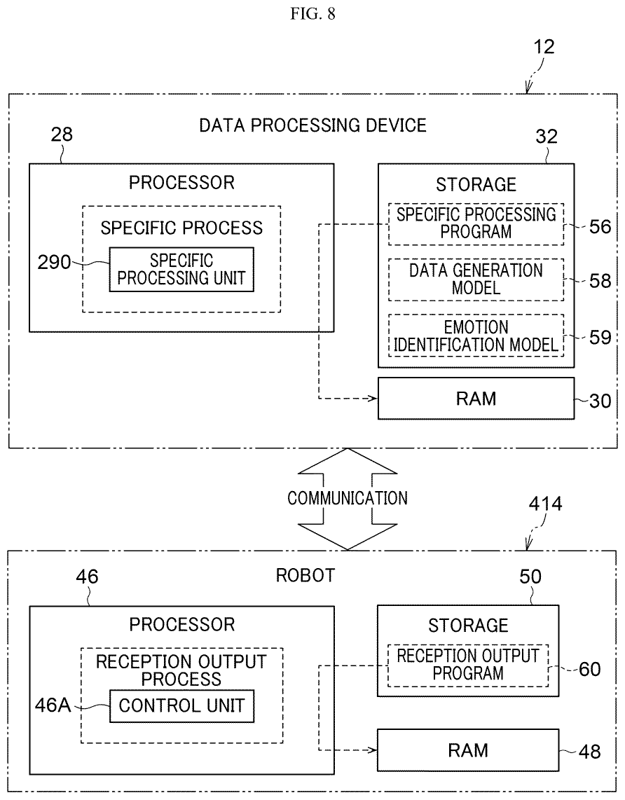

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

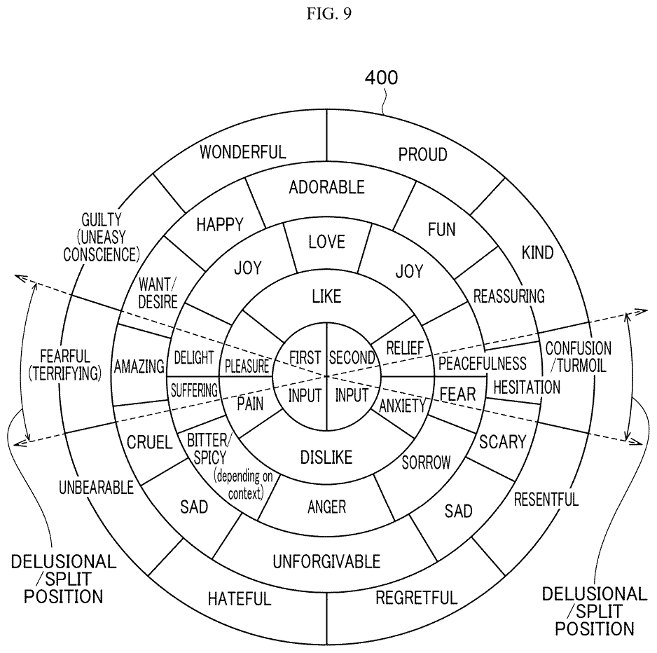

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

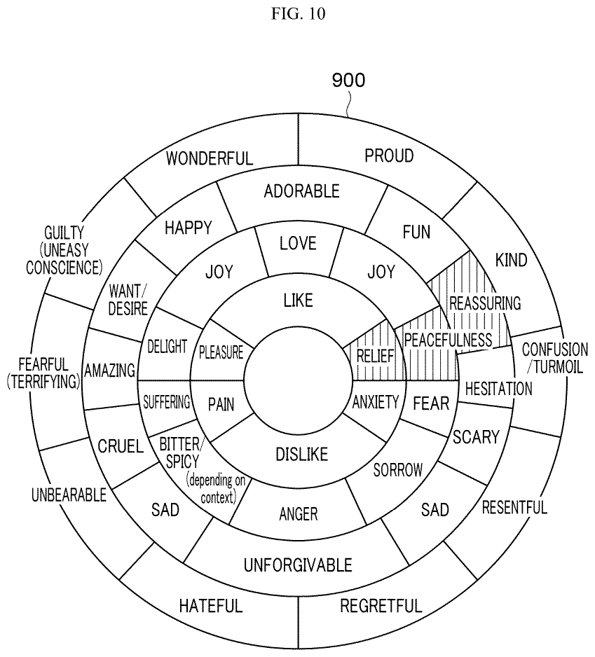

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire attribute information, preference information, and behavior history information of a user from a terminal, and store the information for each user in a storage,
preprocess the stored attribute information, preference information, and behavior history information to convert the information into numerical feature data and text feature data, and
generate input data to be input to a generative artificial intelligence model,
generate a prompt sentence including summary content of the attribute information, preference information, and behavior history information of the user, the prompt sentence instructing the generative artificial intelligence model to estimate interests and preferences of the user and to select candidate targets for the user,
input the prompt sentence and the input data to the generative artificial intelligence model, and cause the generative artificial intelligence model to generate response data including relevance information or explanation information for the candidate targets for the user,
extract matching candidates or service candidates to be presented to the user based on the response data and the stored information, and determine the matching candidates or the service candidates by performing scoring and ranking on the matching candidates or the service candidates,
acquire communication history information between users, generate text information summarizing the communication history information, and generate a prompt sentence including the text information, the prompt sentence instructing the generative artificial intelligence model to extract issues in interpersonal relationships and to generate advice information for the issues,
input the prompt sentence to the generative artificial intelligence model, acquire response data including the advice information from the generative artificial intelligence model, and
present the advice information to the user as communication support information, and
continuously acquire new behavior history information and communication history information of the user, and update the stored information and the input data for the generative artificial intelligence model, thereby successively improving the matching candidates and the advice information.

### Supplementary 2

The system according to supplementary 1,
wherein the processor is configured to
classify a behavior tendency of the user based on the stored behavior history information, generate text information summarizing profile information associated with the behavior tendency, and generate a prompt sentence including the text information, the prompt sentence instructing the generative artificial intelligence model to automatically generate matching candidates according to the behavior tendency.

### Supplementary 3

The system according to supplementary 1,
wherein the processor is configured to
acquire a question sentence input by the user, generate a prompt sentence including the question sentence and summary content of the attribute information, preference information, and behavior history information of the user, the prompt sentence instructing the generative artificial intelligence model to automatically generate an answer sentence to the question sentence, and present the answer sentence acquired from the generative artificial intelligence model to the user.

### Application Example 1

### Supplementary 1

A system comprising a processor,
wherein the processor is configured to
acquire, from a storage medium, user attribute information and past user behavior information, and generate feature information representing a preference and an interest of a user based on the user attribute information and the past user behavior information,
acquire, from a terminal, position information of the user in a physical space, and identify an area in which the user is present based on the position information,
input the feature information and candidate item information associated with the area as input information to a machine learning model, calculate a suitability score for each candidate item, and select one or more candidate items to be presented to the user based on the suitability score,
generate a prompt sentence, based on the feature information, the position information, and attribute information relating to the selected one or more candidate items, the prompt sentence instructing a generative AI model to generate a natural language response to propose the selected one or more candidate items to the user,
transmit, to the terminal, proposal information obtained from the generative AI model by inputting the prompt sentence, as notification information to be presented to the user,
acquire, from the terminal, response information indicating a selection operation of the user with respect to the one or more candidate items included in the notification information, and
store the response information as behavior information of the user in the storage medium, and update at least one of the machine learning model and a generation condition of the prompt sentence based on the response information stored in the storage medium.

### Supplementary 2

The system according to supplementary 1,
wherein the processor is configured to
automatically generate a prompt sentence that instructs the generative AI model to generate a proposal sentence for the one or more candidate items in consideration of a budget condition and a preference condition, based on the position information acquired from the terminal and the past user behavior information.

### Supplementary 3

The system according to supplementary 1,
wherein the processor is configured to
classify the response information acquired from the terminal as a positive response or a negative response to presentation of the one or more candidate items, and dynamically change at least one of instruction content included in the prompt sentence and a selection condition for the one or more candidate items in accordance with a classification result.

### Example 2

### Supplementary 1

A system comprising a processor and a storage apparatus,
wherein the processor is configured to
acquire attribute information, preference information, and behavior history information relating to a user entity from the storage apparatus, and generate profile information of the user entity on the basis of the attribute information, the preference information, and the behavior history information,
acquire communication content transmitted and received between user entities, and perform natural language analysis processing on the communication content to extract intention information of the communication content and situational information related to the communication content,
construct a prompt sentence for input to a generative AI model on the basis of the profile information and the intention information, and generate the prompt sentence that defines generation conditions of response information by the generative AI model,
input the prompt sentence to the generative AI model to cause the generative AI model to generate a plurality of response candidate pieces of information for the communication content, and select, from generation results, response candidate information to be presented to the user entity,
transmit the selected response candidate information to a terminal apparatus and cause the terminal apparatus to display the response candidate information in a form selectable by the user entity, and
acquire selection result information relating to response candidate information selected by the user entity from the terminal apparatus, or response information generated by editing the response candidate information, store the selection result information as the behavior history information, and reflect the selection result information in generation of the profile information and the prompt sentence.

### Supplementary 2

The system according to supplementary 1,
wherein the processor is configured to
generate the prompt sentence such that, on the basis of budget constraint information, activity preference information, and communication style information included in the profile information, the prompt sentence instructs the generative AI model to generate proposal information including, together with the response information to the communication content, a budget condition of the user entity and an activity candidate.

### Supplementary 3

The system according to supplementary 1,
wherein the processor is configured to
generate the prompt sentence such that, on the basis of a selection history of past response candidate information included in the behavior history information, the prompt sentence instructs the generative AI model to preferentially generate response candidate information having a writing style, a length, and a tone approximating a response style preferred by the user entity in the past.

### Application Example 2

### Supplementary 1

A system comprising a processor,
wherein the processor is configured to
obtain attribute information, interest information, and behavior history information of a user, and analyze the obtained information to generate structured data representing a state of the user,
generate a prompt sentence including instruction content for causing a generative information processing model to execute at least one of matching, provision of advice, generation of an activity plan, and proposal of a settlement method, based on the structured data and communication content data obtained from the user,
input the prompt sentence to the generative information processing model and obtain response text data generated by the generative information processing model,
perform emotion analysis on text data or audio data obtained from the user and specify emotion information indicating an emotional state of the user,
adjust at least one of a matching candidate, advice content, the activity plan, and the proposal of the settlement method, and/or at least a part of the prompt sentence, based on the emotion information, and
generate output data for transmission to a terminal device, the output data including the response text data generated by the generative information processing model, so that the response text data is displayed on the terminal device.

### Supplementary 2

The system according to supplementary 1,
wherein the processor is configured to
perform preprocessing on input text data from the user by a natural language processing method to extract intent information and constraint information, and generate the prompt sentence including the intent information and the constraint information, input the prompt sentence to the generative information processing model, and thereby automatically generate at least one of an answer relating to an electronic transaction, advice relating to a human relationship, and an activity plan.

### Supplementary 3

The system according to supplementary 1,
wherein the processor is configured to
receive, from the terminal device, facial expression information and audio information of a user acquired by an imaging device and an audio acquisition device included in the terminal device, specify the emotion information based on the facial expression information and the audio information, generate the prompt sentence including the emotion information, input the prompt sentence to the generative information processing model to generate at least one of a customer service response sentence and a communication support sentence, and transmit the at least one of the customer service response sentence and the communication support sentence to the terminal device.

What is claimed is:

1. A system comprising:
circuitry configured to:
receive, via a communication interface coupled to a packet-switched network, user data from a terminal device, the user data including a profile, interest information, and past behavior history information of a user, and store the user data in a storage device;
analyze the user data using a generative AI model and generate a prompt sentence for instructing the generative AI model to determine matching candidates based on a result of the analysis;
analyze, using the generative AI model, a conversation or a message received from the terminal device via the communication interface and generate a prompt sentence for instructing the generative AI model to provide communication support based on a result of the analysis; and
recognize an emotion of the user based on the user data and generate a prompt sentence for instructing adjustment of matching candidates based on the recognized emotion, and transmit a result generated by the generative AI model to the terminal device via the communication interface.

2. The system according to claim 1, wherein the circuitry is configured to preprocess the user data to generate numerical feature data and text feature data as unified input data, and generate prompt sentences that include summaries of the user data and that instruct the generative AI model to estimate user interests and preferences and to select candidate targets.

3. The system according to claim 2, wherein the circuitry is configured to input the prompt sentences and the unified input data to the generative AI model, obtain response data including relevance information, explanation information, and advice information, and determine matching candidates by extracting, scoring, and ranking candidates based on the response data.

4. The system according to claim 3, wherein the circuitry is configured to continuously update the user data stored in the storage device based on newly acquired behavior history information and communication history information, and iteratively refine subsequent determinations of matching candidates based on the updated user data.

5. The system according to claim 1, wherein the circuitry is configured to generate a prompt sentence for instructing automatic generation, by the generative AI model, of a matching candidate based on a behavior pattern of the user derived from the behavior history information.

6. The system according to claim 1, wherein the circuitry is configured to generate a prompt sentence for instructing automatic generation, by the generative AI model, of an answer to a question received from the terminal device via the communication interface.

7. The system according to claim 6, wherein the circuitry is configured to extract issues in interpersonal relationships from communication history information stored in the storage device, and generate a prompt sentence instructing the generative AI model to generate advice information addressing the extracted issues.

8. The system according to claim 1, wherein the circuitry is configured to generate prompt sentences that instruct the generative AI model to extract and score communication issues from conversation data received via the communication interface, and provide communication strategy suggestions to the terminal device based on output of the generative AI model.

9. The system according to claim 8, wherein the circuitry is configured to generate context-aware reply suggestions based on output of the generative AI model and transmit the reply suggestions to the terminal device via the communication interface.

10. The system according to claim 1, wherein the circuitry is configured to recognize the emotion of the user by analyzing at least one of text content, selection behavior, and reaction patterns extracted from the user data, and generate the prompt sentence for adjusting matching candidates to reflect the recognized emotional state.

11. The system according to claim 10, wherein the circuitry is configured to adjust at least one of a selection criterion and a presentation order of matching candidates based on the recognized emotional state prior to transmitting the matching candidates to the terminal device.

12. The system according to claim 1, wherein the circuitry is configured to acquire attribute information, preference information, behavior history information, and communication history information of a plurality of users from respective terminal devices via the communication interface, and store the acquired information in the storage device in association with respective users.

13. The system according to claim 12, wherein the circuitry is configured to generate prompt sentences that instruct the generative AI model to estimate compatibility between users based on the stored attribute information and preference information, and score and rank candidate matches based on output of the generative AI model.

14. The system according to claim 1, wherein the circuitry is configured to generate prompt sentences that instruct the generative AI model to analyze temporal changes in behavior history information of the user, and update matching criteria based on detected changes in user preferences over time.

15. The system according to claim 1, wherein the circuitry is configured to store prompt sentences generated for a user in the storage device in association with the user, and reuse stored prompt sentences when generating updated matching candidates for the user based on updated behavior history information.

16. The system according to claim 1, wherein the circuitry is configured to present determined matching candidates and advice information to the terminal device, receive user feedback on presented candidates via the communication interface, and incorporate the feedback into subsequent prompt sentence generation.

17. The system according to claim 16, wherein the circuitry is configured to update a preference model stored in the storage device based on user feedback received from the terminal device, and use the updated preference model when generating prompt sentences for subsequent matching operations.

18. A system comprising:
circuitry configured to:
receive, via a communication interface coupled to a packet-switched network, user data from a terminal device, the user data including attribute information, preference information, behavior history information, and communication history information, and store the user data in a storage device;
preprocess the stored user data to generate unified input data, and generate prompt sentences instructing a generative AI model to estimate user interests and preferences, select candidate targets, and generate advice information;
input the prompt sentences and the unified input data to the generative AI model, obtain response data, and determine matching candidates by extracting, scoring, and ranking candidates based on the response data; and
transmit the matching candidates and the advice information to the terminal device via the communication interface, and update the user data based on newly acquired behavior history information to iteratively refine subsequent determinations of matching candidates.

19. The system according to claim 18, wherein the circuitry is configured to recognize an emotion of the user based on the user data stored in the storage device, and generate a prompt sentence instructing the generative AI model to adjust the matching candidates based on the recognized emotion.

20. A method comprising:
receiving, via a communication interface coupled to a packet-switched network, user data from a terminal device, the user data including a profile, interest information, and past behavior history information of a user, and storing the user data in a storage device;
analyzing the user data using a generative AI model and generating a prompt sentence for instructing the generative AI model to determine matching candidates based on a result of the analysis;
analyzing, using the generative AI model, a conversation or a message received from the terminal device via the communication interface and generating a prompt sentence for instructing the generative AI model to provide communication support based on a result of the analysis; and
recognizing an emotion of the user based on the user data and generating a prompt sentence for instructing adjustment of matching candidates based on the recognized emotion, and transmitting a result generated by the generative AI model to the terminal device via the communication interface.
